(19) United States
(12) Patent Application Publication
(10) Pub. No.: US 2026/0099220 A1
(43) Pub. Date: Apr. 9, 2026

(54) ELECTRONIC PEN

(71) Applicant: Wacom Co., Ltd., Saitama (JP)

(72) Inventors: Kohei TANAKA, Saitama (JP); Takenori KANEDA, Saitama (JP); Hock Meng WAN, Saitama (JP)

(73) Assignee: Wacom Co., Ltd., Saitama (JP)

(21) Appl. No.: 19/415,514

(22) Filed: Dec. 10, 2025

Related U.S. Application Data
(63) Continuation of application No. PCT/JP2023/021918, filed on Jun. 13, 2023.

(51) Int. Cl. G06F 3/0354; G06F 3/041; G06F 3/044; G06F 3/046

(52) U.S. Cl. CPC G06F 3/03545; G06F 3/0416; G06F 3/044; G06F 3/046

(57) ABSTRACT

An electronic pen includes first and a second casings constituting an outer casing by being coupled to each other in an axial direction, and an electronic pen main body having a function of performing signal interaction with a position detecting sensor. The electronic pen main body has a columnar shape, is capable of being fitted with a core body on one end side in the axial direction, and has an electric first terminal on a side opposite to the side fitted with the core body. The electronic pen includes an additional unit disposed on a side opposite to the core body side of the electronic pen main body in the axial direction and electrically coupled to the electronic pen main body. The additional unit has a columnar shape and has, on one end side in the axial direction, a second terminal electrically coupled to the first terminal.

### BACKGROUND

### Technical Field

The present disclosure relates to an electronic pen that has a function of performing signal interaction with a position detecting sensor and has an additional part such as a charging terminal.

### Description of the Related Art

An active capacitive type electronic pen and an electromagnetic induction type electronic pen are well known as electronic pens. The active capacitive type electronic pen includes a signal transmitting circuit that transmits a signal for performing interaction with a position detecting sensor, and also includes a power supply that supplies a power supply voltage to the signal transmitting circuit. In addition, in a case where the electromagnetic induction type electronic pen transmits pen pressure information and identification information as digital information to an electronic apparatus side including the position detecting sensor, the electromagnetic induction type electronic pen includes a circuit that generates the digital information, and also includes a power supply that supplies a power supply voltage to the circuit. Moreover, in a case where a rechargeable battery is used as the power supply, the electronic pen is often provided with a charging terminal.

A conventional electronic pen is configured by electrically coupling a part having a function of performing signal interaction with the position detecting sensor (functional part of an electronic pen main body) to an additional part such as a power supply and is configured to house these parts in a columnar housing space in an electronic pen outer casing, regardless of whether the conventional electronic pen is an active capacitive type electronic pen or an electromagnetic induction type electronic pen.

Recently, as illustrated in the domestic re-publication of PCT Patent Publication WO2020/148977 and the domestic re-publication of PCT Patent Publication WO2017/010336, for example, there has also been proposed an electronic pen which is configured such that internal parts of the electronic pen are modularized and the modularized parts are housed in a columnar housing space in an electronic pen outer casing. Also in this case, a functional part of an electronic pen main body, which has a function of performing signal interaction with the position detecting sensor, and an additional part such as a power supply are electrically coupled to each other, and are configured as one modularized part.

However, in the electronic pen of the conventional configuration as described above, only a core body having a pen tip is a replaceable part, and the electronic pen itself needs to be replaced as a whole both when the electronic pen outer casing of the electronic pen is damaged and when some of the internal parts are broken.

Therefore, when the electronic pen outer casing of the electronic pen is damaged, an internal module that operates normally is also discarded. In addition, when a part other than a power supply unit of the modularized part is damaged, the power supply unit that is normal is also discarded. Further, when only a part of the power supply unit is broken, the other part that is not broken in the modularized part is also discarded.

Such conditions are not preferable also from a viewpoint of sustainability, and there is a desire for a higher degree of repairability of the electronic pen.

In addition, in a case where the modularized part housed in the electronic pen outer casing of the electronic pen is not inhibited from rotating about an axial direction in the columnar housing space in the electronic pen outer casing, what is generally called one-sided wear tends to occur at a distal end of the core body when the electronic pen is used while inclined with respect to an input surface of the position detecting sensor, for example. That is, even when a user uses the electronic pen while slightly rotating the electronic pen outer casing about the axial direction in order to prevent one-sided wear of the core, the modularized part freely rotates about the axial direction in the electronic pen outer casing, and therefore, the same part of the distal end of the core body abuts against the input surface at all times. Thus, the one-sided wear tends to occur.

### BRIEF SUMMARY

It is an object of the present disclosure to provide an electronic pen that can solve the above problems.

In order to solve the above problems, there is provided an electronic pen including a first casing and a second casing configured to constitute an electronic pen outer casing by being coupled to each other in an axial direction, and an electronic pen main body that has a function of performing signal interaction with a position detecting sensor, that has a columnar shape capable of being housed in the electronic pen outer casing, and that is capable of being fitted with a core body on one end side in the axial direction. There is also an additional unit disposed on a side opposite to the core body side of the electronic pen main body in the axial direction and electrically coupled to the electronic pen main body. The electronic pen main body has an electric first terminal on a side opposite to the side fitted with the core body. The additional unit has a columnar shape capable of being housed in the electronic pen outer casing and has a second terminal on one end side in the axial direction. The second terminal is configured to be electrically coupled to the first terminal of the electronic pen main body. In the electronic pen outer casing, the electronic pen main body and the additional unit, arranged in such a manner as to be aligned with each other in the axial direction in a state in which the additional unit is on a rear end side, are incapable of movement in the axial direction. The first terminal and the second terminal are electrically coupled to each other, and at least the electronic pen main body is incapable of rotation about the axial direction with respect to the electronic pen outer casing.

Constituent parts of the electronic pen of the above-described configuration are constituted by four parts, that is, the electronic pen main body, the additional unit, the first casing, and the second casing. Further, the electronic pen can be constructed by merely housing the electronic pen main body and the additional unit in the electronic pen outer casing constituted by a first casing and a second casing, in such a manner as to couple the electronic pen main body and the additional unit to each other in the axial direction.

Hence, according to the electronic pen of the above-described configuration, when one of the four parts is damaged, the electronic pen can be repaired by replacing only the damaged part, so that a higher degree of repairability of the electronic pen can be achieved.

In addition, the electronic pen main body is set in a state of being incapable of rotation about the axial direction in the electronic pen outer casing. Therefore, when the user uses the electronic pen while gradually rotating the electronic pen outer casing about the axial direction in order to prevent one-sided wear of the core, the electronic pen main body also rotates together with the inside of the electronic pen outer casing. Thus, one-sided wear of a distal end of the core body can be prevented.

### BRIEF DESCRIPTION OF THE SEVERAL VIEWS OF THE DRAWINGS

FIGS. 1A, 1B, and 1C are a perspective view and exploded perspective views explaining an example of a configuration of an electronic pen according to an embodiment of the present disclosure;

FIGS. 2A and 2B are a perspective view and an exploded perspective view of the configuration example of the electronic pen according to the embodiment of the present disclosure as viewed from another angle;

FIGS. 3A, 3B, and 3C are exploded perspective views explaining principal parts of the configuration example of the electronic pen according to the embodiment of the present disclosure;

FIGS. 4A and 4B are diagrams explaining the part of a side switch in the configuration example of the electronic pen according to the embodiment of the present disclosure;

FIGS. 5A and 5B are sectional views of a state in which an electronic pen main body constituting the electronic pen according to the embodiment of the present disclosure is housed in a pen tip side casing;

FIGS. 6A, 6B, and 6C are diagrams explaining an additional unit constituting the electronic pen according to the embodiment of the present disclosure and a state of electric connection between the additional unit and the electronic pen main body;

FIG. 7 is a circuit diagram illustrating an example of an electric configuration of the electronic pen main body and the additional unit constituting the electronic pen according to the embodiment of the present disclosure;

FIG. 8 is a diagram explaining another example of the configuration of the principal parts of the electronic pen according to the embodiment of the present disclosure;

FIGS. 9A, 9B, and 9C are diagrams explaining yet another example of the configuration of the principal parts of the electronic pen according to the embodiment of the present disclosure;

FIG. 10 is a diagram illustrating an example of a configuration of coupling structures in which consideration is given to alignment between a pen tip side casing and a rear end side casing of the electronic pen according to the embodiment of the present disclosure;

FIG. 11 is a diagram illustrating an example of a configuration of a terminal on the rear end side of an electronic pen main body constituting the electronic pen according to the embodiment of the present disclosure;

FIGS. 12A, 12B, 12C, 12D, and 12E are diagrams explaining another example of the configuration of the coupling structures in which consideration is given to alignment between the pen tip side casing and the rear end side casing of the electronic pen according to the embodiment of the present disclosure;

FIG. 13 is a diagram explaining still another example of the configuration of the coupling structures in which consideration is given to alignment between the pen tip side casing and the rear end side casing of the electronic pen according to the embodiment of the present disclosure;

FIGS. 14A and 14B are diagrams explaining yet another example of the configuration of the coupling structures in which consideration is given to alignment between the pen tip side casing and the rear end side casing of the electronic pen according to the embodiment of the present disclosure;

FIG. 15 is a circuit diagram illustrating an example of an electric configuration of an electronic pen main body and an additional unit constituting the electronic pen according to another embodiment of the present disclosure;

FIGS. 16A, 16B, and 16C are diagrams illustrating examples of configurations of electrodes of the terminal on the rear end side of the electronic pen main body constituting the electronic pen according to the embodiment of the present disclosure and examples of configurations of electrodes on the additional unit side; and

FIGS. 17A, 17B, 17C, and 17D are diagrams illustrating other examples of the configuration of the electrodes of a terminal on the rear end side of an electronic pen main body constituting the electronic pen according to the embodiment of the present disclosure and another example of the configuration of the electrodes on the additional unit side.

### DETAILED DESCRIPTION

An embodiment of an electronic pen according to the present disclosure will hereinafter be described with reference to the drawings. The embodiment of the electronic pen to be described in the following represents a case of an active capacitive type electronic pen.

### Outline of Configuration of Electronic Pen According To Embodiment

An electronic pen 1 according to the present embodiment uses a secondary battery as a power supply, and has a charging terminal. The electronic pen 1 is thus configured to be capable of being charged as appropriate.

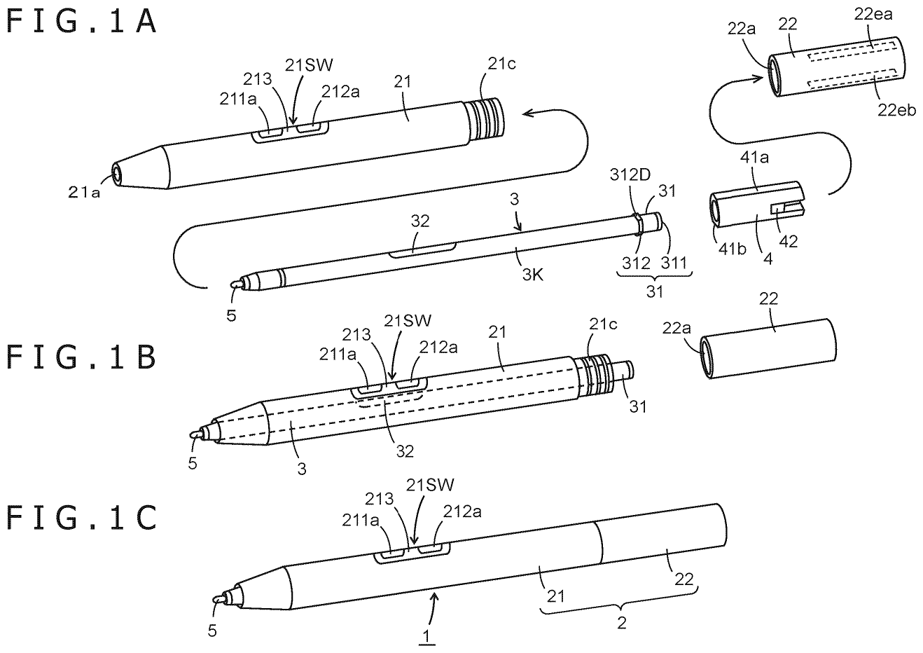

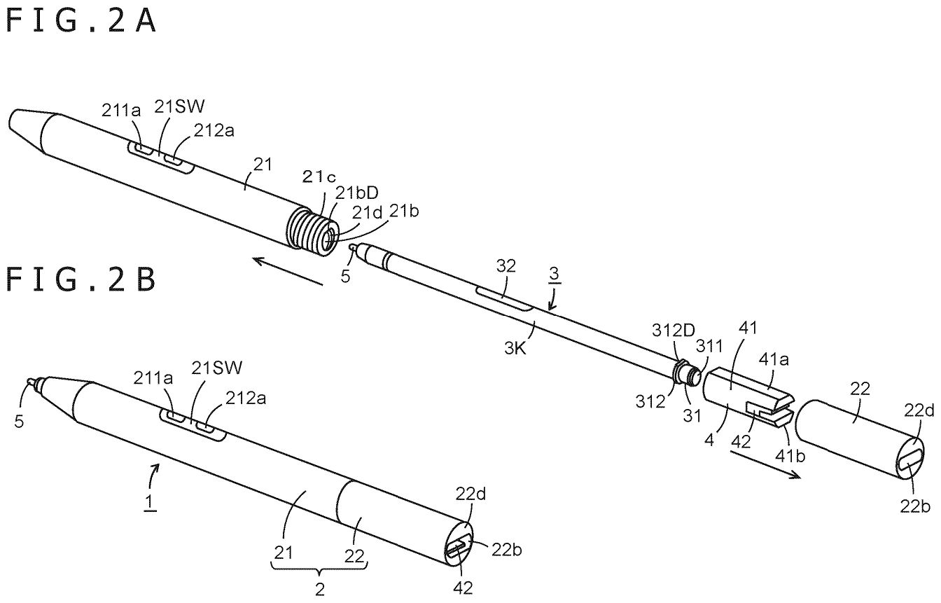

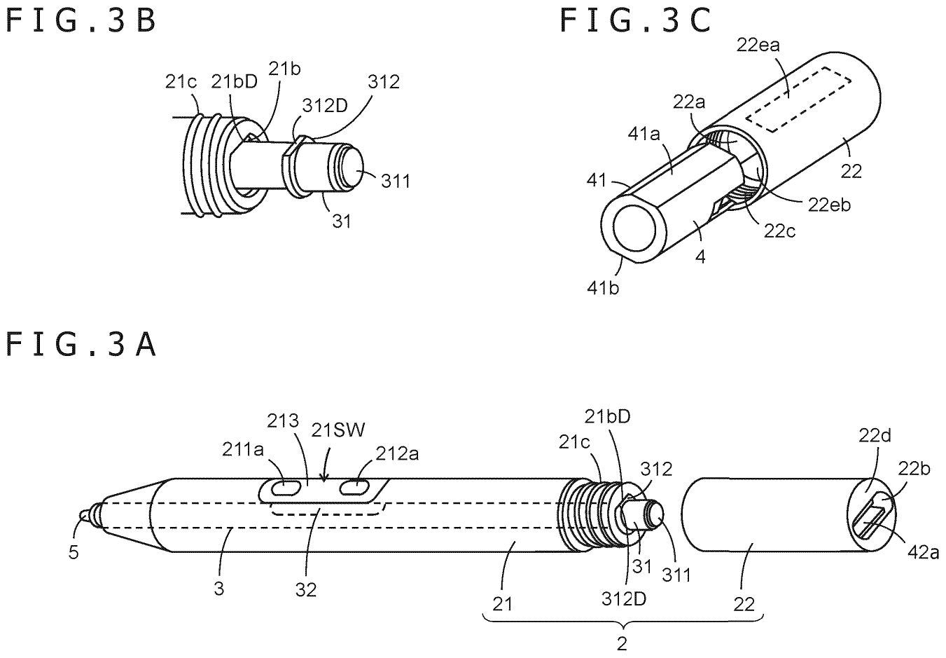

FIGS. 1A to 1C, FIGS. 2A and 2B, and FIGS. 3A to 3C are diagrams explaining an outline of an example of a configuration of the electronic pen 1 according to the present embodiment. FIGS. 1A to 1C are diagrams as viewed from an obliquely forward direction in which an opening on a pen tip side of an electronic pen outer casing 2 of the electronic pen 1 is visible. FIGS. 2A and 2B are diagrams as viewed from an obliquely rearward direction in which an end surface of the electronic pen outer casing 2 of the electronic pen 1 which is on a rear end side opposite to the pen tip side is visible. FIGS. 3A to 3C are diagrams explaining a state during the middle of a procedure of assembling the electronic pen 1 according to the present embodiment.

FIG. 1A and FIG. 2A are exploded perspective views explaining constituent parts of the electronic pen 1 according to the present embodiment. In addition, FIG. 1C and FIG. 2B are diagrams illustrating an external appearance of the assembled electronic pen 1.

In the present embodiment, the electronic pen outer casing 2 of the electronic pen 1 according to the present embodiment is divided in two in the axial direction of a cylindrical shape thereof and is formed by detachably coupling a first casing and a second casing as unit parts to each other. As illustrated in FIGS. 1A to 1C, FIGS. 2A and 2B, and FIGS. 3A to 3C, in the present example, the electronic pen outer casing 2 is formed by a pen tip side casing 21 as an example of the first casing and a rear end side casing 22 as an example of the second casing. The pen tip side casing 21 and the rear end side casing 22 are formed of an insulative material, or resin in the present example, and have an elongated cylindrical shape, internally having a columnar housing space.

As illustrated in FIG. 1A and FIG. 2A, the pen tip side casing 21 has a cylindrical shape, internally having a hollow space. One end side in the axial direction of a pen tip side of the pen tip side casing 21 has such a shape as to be tapered off gradually. In addition, the pen tip side casing 21 has, on the pen tip side, an opening 21a (see FIG. 1A) for making a distal end of a core body to be described later protrude outward. Moreover, a rear end side of the pen tip side casing 21 in the axial direction which is opposite to the pen tip side has an opening 21b (see FIG. 2A), and in the present example, an outer peripheral wall surface of the pen tip side casing 21, the outer peripheral wall surface in the vicinity of the opening 21b on the rear end side has a threaded surface 21c formed thereon for coupling to the rear end side casing 22 by screwing.

As illustrated in FIG. 1A and FIG. 2A, the rear end side casing 22 has a cylindrical shape, internally having a hollow space, and an inner wall surface of an opening 22a on one end side in the axial direction of the rear end side casing 22. The one end side is on the pen tip side casing 21 side and has a threaded surface 22c (see FIG. 3C) formed thereon to be screwed onto the threaded surface 21c of the pen tip side casing 21. Moreover, in the present example, as illustrated in FIG. 2A, the rear end side casing 22 has a configuration of a bottomed tubular body having a lid (bottom surface) 22d formed by a flat plate on the rear end side of the rear end side casing 22, and the rear end side casing 22 is formed with an opening 22b provided in the lid 22d. In the present example, the opening 22b has the shape of an elongated hole passing through the center of the lid 22d, and a terminal plate 42a of a universal serial bus (USB) connector 42 is exposed from the opening 22b as the elongated hole.

Moreover, in the present embodiment, the electronic pen outer casing 2 of the electronic pen 1 is formed by screwing the threaded surface 21c of the pen tip side casing 21 and the threaded surface 22c of the rear end side casing 22 to each other.

In the electronic pen 1 according to the present embodiment, the unit parts housed in the electronic pen outer casing 2 are two unit parts, that is, an electronic pen main body 3 and an additional unit 4. In the present embodiment, the additional unit 4 is a charging terminal unit. In the present example, the additional unit 4 has a configuration using a USB connector.

In the electronic pen 1 according to the present embodiment, before the pen tip side casing 21 and the rear end side casing 22 are screwed and coupled to each other, as illustrated in FIG. 1A and FIG. 2A, the electronic pen main body 3 is inserted and housed into the pen tip side casing 21 from the opening 21b on the rear end side, and the additional unit 4 is inserted and housed into the rear end side casing 22 from the opening 22a on the pen tip side. In this case, in the present embodiment, the electronic pen main body 3 is housed in the pen tip side casing 21 in a state in which the electronic pen main body 3 is unable to rotate about the axial direction with respect to the pen tip side casing 21. In addition, the additional unit 4 is housed in the rear end side casing 22 in a state in which the additional unit 4 is unable to rotate about the axial direction with respect to the rear end side casing 22.

### Structure for Housing Electronic Pen Main Body 3 in Pen Tip Side Casing 21

The rear end side of the electronic pen main body 3 is provided with a terminal 31 constituting an example of a first terminal for effecting an electric connection to the additional unit 4. The terminal 31 includes a first contact 311 constituted by a circular electrode formed in such a manner as to be exposed on a circular end surface on the rear end side in the axial direction of the electronic pen main body 3 and a second contact 312 constituted by an electrode of a flange-shaped portion that protrudes in a ring shape from a side circumferential surface of a cylindrical main body casing 3K of the electronic pen main body 3. The main body casing 3K in the present embodiment is constituted by a metallic pipe formed of a conductive metal, for example, stainless used steel (SUS).

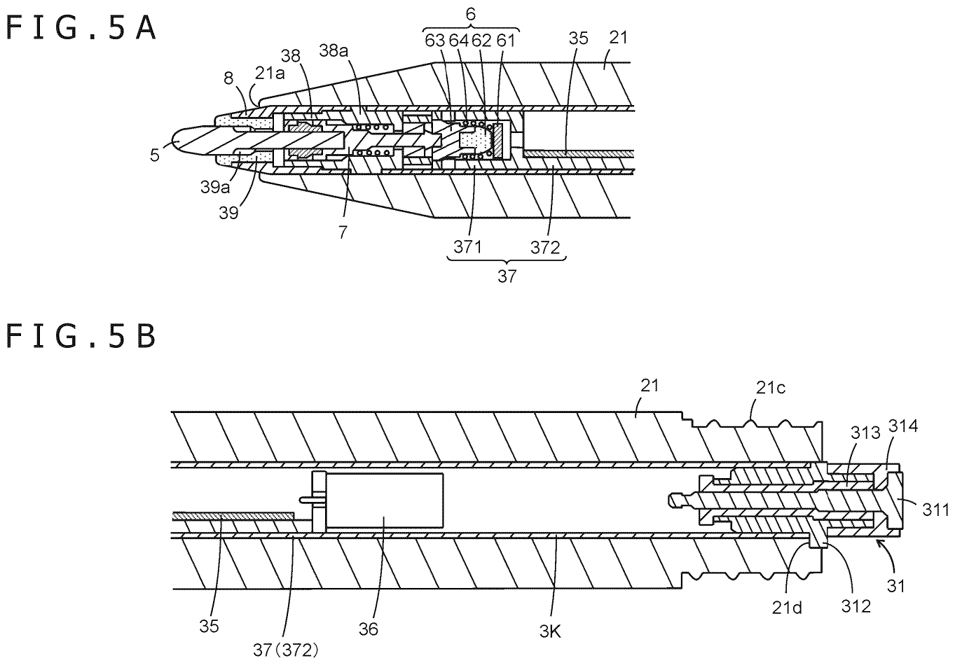

In the present example, as illustrated in FIG. 1A, FIG. 2A, and FIG. 3B, the flange-shaped portion constituting the second contact 312 has what is generally called a D-cut shape, obtained by forming a predetermined angular range part in the circumferential part protruding in a ring shape into a plane 312D. Incidentally, the second contact 312 is in direct contact with the conductive metallic main body casing 3K (see FIGS. 5A and 5B to be described later), and the two are therefore electrically coupled to each other.

Moreover, as illustrated in FIG. 2A and FIGS. 3A and 3B, the opening 21b of the rear end side of the pen tip side casing 21 is formed as an opening in a D-cut shape, into which the second contact 312 is fitted, in such a manner as to correspond to the flange-shaped portion in the D-cut shape of the second contact 312. That is, the opening 21b on the rear end side of the pen tip side casing 21 has a diameter equal to or slightly larger than the diameter of the second contact 312 and is formed in a shape having a linear portion 21bD corresponding to the plane 312D in the D-cut shape of the second contact 312. In the present example, the part of the opening 21b having a shape corresponding to the shape of the second contact 312 is formed over a length which is the same as the width of the flange-shaped portion of the second contact 312 in the axial direction.

Moreover, the diameter of a cylindrical hollow portion of the pen tip side casing 21 is larger than the diameter of the main body casing 3K of the electronic pen main body 3. A vicinity of the opening 21b on the rear end side of the pen tip side casing 21 has a diameter larger than the diameter of the cylindrical hollow portion of the pen tip side casing 21. Therefore, as illustrated in FIG. 2A, a step 21d is formed on an inner wall surface of the opening 21b on the rear end side of the pen tip side casing 21.

Hence, when the electronic pen main body 3 is inserted into the pen tip side casing 21, the flange-shaped portion of the second contact 312 of the electronic pen main body 3 is engaged with the step 21d in the vicinity of the opening 21b of the pen tip side casing 21, and is locked without being further moved toward the opening 21a side of the pen tip side casing 21 (FIG. 1B and see FIG. 3A).

In this case, when the plane 312D of the flange-shaped portion of the second contact 312 of the electronic pen main body 3 and the linear portion 21bD of the opening 21b of the pen tip side casing 21 are aligned with each other, the second contact 312 is fitted into the opening 21b, and the flange-shaped portion of the second contact 312 is engaged with the step 21d in the vicinity of the opening 21b. Then, the plane 312D is engaged with the linear portion 21bD, and thereby the electronic pen main body 3 is locked in a state of being unable to rotate about the axial direction with respect to the pen tip side casing 21.

In this state, as illustrated in FIG. 1B and FIG. 3A, a predetermined part on the pen tip side of the electronic pen main body 3 protrudes outward from the opening 21a of the pen tip side casing 21. Incidentally, a distal end of the part of the electronic pen main body 3 which part protrudes outward from the opening 21a of the pen tip side casing 21 is provided with a core body 5 formed of a conductive material, for example, a conductive metal. In the present embodiment, the core body 5 is configured to be detachable from the electronic pen main body 3. The configuration described above can prevent one-sided wear of the core body 5 in the electronic pen 1 according to the present embodiment.

### Configuration Related to Side Switch

In the present embodiment, the electronic pen main body 3 has what is generally called a side switch, and an operator 32 for turning on and/or off the side switch is provided at a predetermined position of the side circumferential surface of the main body casing 3K. That is, in the present example, the side switch provided in the electronic pen main body 3 is turned on and/or off by the operator 32 being pressed from the outside.

The operator 32 (hereinafter referred to as a switch driving operator 32 for convenience) is provided at a predetermined position in the axial direction of the main body casing 3K and at a predetermined angular range position in a circumferential direction thereof in such a manner as to be capable of performing on-off operation of the switch disposed on a board in the electronic pen main body 3. In the present embodiment, the electronic pen main body 3 is housed in the pen tip side casing 21, and therefore, a user cannot directly operate the switch driving operator 32 of the electronic pen main body 3.

In the present embodiment, the pen tip side casing 21 is provided with an operator 21SW (hereinafter referred to as a side switch operator 21SW for convenience), and the user operates the side switch operator 21SW to drive the switch driving operator 32 of the electronic pen main body 3 housed in the pen tip side casing 21. The side switch in the electronic pen main body 3 is configured to be able to be thereby turned on and/or off. To this end, in the present embodiment, alignment is performed such that the side switch operator 21SW of the pen tip side casing 21 is located directly above the switch driving operator 32 of the electronic pen main body 3 when the electronic pen main body 3 is inserted and housed in the pen tip side casing 21.

In the present embodiment, alignment between the switch driving operator 32 of the electronic pen main body 3 and the side switch operator 21SW of the pen tip side casing 21 is performed by the D-cut shape of the second contact 312 of the electronic pen main body 3 and the corresponding shape of the opening 21b on the rear end side of the electronic pen main body 3 and by the fitting of the second contact 312 to the opening 21b on the rear end side.

That is, in the present embodiment, a positional relation between an angular position of the switch driving operator 32 of the electronic pen main body 3 in the circumferential direction of a peripheral side surface of the main body casing 3K and an angular position of the plane 312D in the D-cut shape of the second contact 312 of the electronic pen main body 3 in the circumferential direction of the peripheral side surface of the main body casing 3K are configured to be the same as a positional relation between an angular position of the side switch operator 21SW of the pen tip side casing 21 in the circumferential direction of a peripheral side surface of the pen tip side casing 21 and an angular position of the linear portion 21bD of the opening 21b of the pen tip side casing 21 in the circumferential direction of the peripheral side surface of the pen tip side casing 21. In the present embodiment, as illustrated in FIG. 1A, FIG. 2A, and FIGS. 3A and 3B, the switch driving operator 32 of the electronic pen main body 3 and the plane 312D of the second contact 312 are provided at the same angular position in the circumferential direction of the peripheral side surface of the main body casing 3K, and the side switch operator 21SW of the pen tip side casing 21 and the linear portion 21bD of the opening 21b are provided at the same angular position in the circumferential direction of the peripheral side surface of the pen tip side casing 21. Thus, what is obtained is the side switch operator 21SW of the pen tip side casing 21 is located precisely at a position directly above the switch driving operator 32 of the electronic pen main body 3 when the second contact 312 of the electronic pen main body 3 is being fitted and locked to the rear end side opening 21b of the pen tip side casing 21 after the electronic pen main body 3 is inserted into the pen tip side casing 21.

Further, in the present embodiment, the formation position in the axial direction of the operator 32 in the electronic pen main body 3 and the formation position in the axial direction of the operator 21SW of the pen tip side casing 21 are set to have such a relation that, as indicated by a dotted line in FIG. 1B and FIG. 3A, the operator 21SW of the pen main body 3 is located directly above the operator 32 of the electronic pen main body 3 when the second contact 312 of the electronic pen main body 3 is being fitted and locked to the rear end side opening 21b of the pen tip side casing 21 after the electronic pen main body 3 is inserted into the pen tip side casing 21.

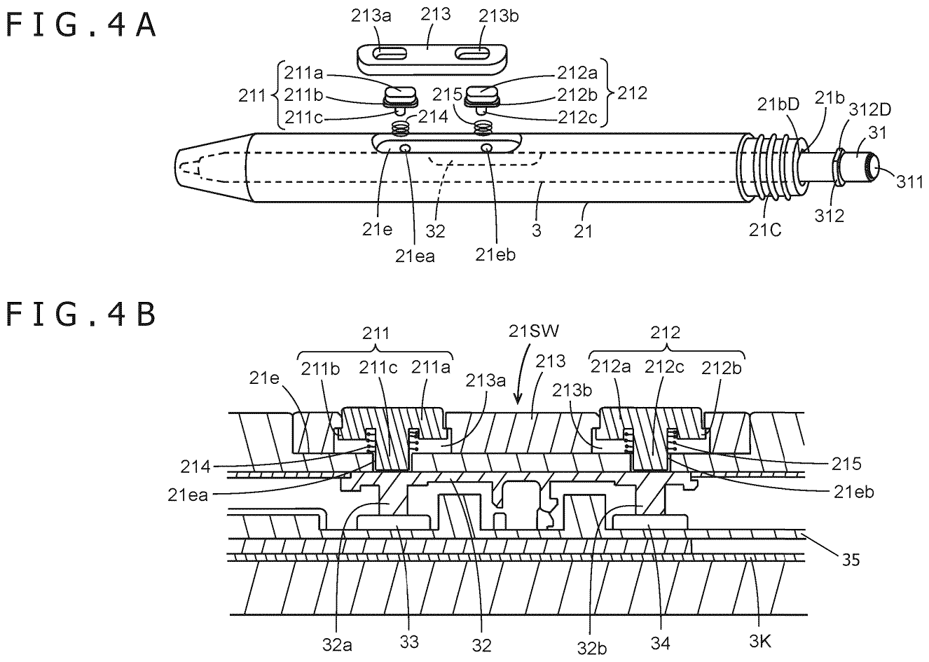

FIG. 4A is a diagram illustrating an example of a configuration of the operator 21SW of the pen tip side casing 21. In addition, FIG. 4B is a sectional view explaining the side switch operator 21SW of the pen tip side casing 21 and the side switch of the electronic pen main body 3 as well as the switch driving operator 32 and vicinities thereof.

In the present embodiment, as illustrated in FIG. 4B, the electronic pen main body 3 is provided with two switches 33 and 34 arranged as the side switch on a circuit board 35. The switches 33 and 34 in the present example are a self-returning switch that returns to an original position when a depression force is released.

The switch driving operator 32 has a configuration of an elongated thin plate shape, and has legs 32a and 32b for on-off driving of the switches 33 and 34. Moreover, the switch driving operator 32 is attached to the main body casing 3K of the electronic pen main body 3 in such a manner as to be capable of a seesaw movement with a central portion in a longitudinal direction of the switch driving operator 32 as a fulcrum position. Further, when a depression force is applied to the leg 32a side, the leg 32a depresses the switch 33 and thereby turns on and/or off the switch 33. In addition, when a depression force is applied to the leg 32b side, the leg 32b depresses the switch 34 and thereby turns on and/or off the switch 34.

As illustrated in FIG. 4A, an elongated hole 21e for housing the side switch operator 21SW is provided at a position in the axial direction of the pen tip side casing 21, that is, a position above a part in which the switch driving operator 32 is located when the second contact 312 is fitted to the opening 21b after the electronic pen main body 3 is inserted into the pen tip side casing 21.

In the present example, as illustrated in FIGS. 4A and 4B, the side switch operator 21SW includes two operating knobs 211 and 212 corresponding to the two switches 33 and 34, respectively, a knob bezel 213 for holding the operating knobs 211 and 212 in the elongated hole 21e, and coil springs 214 and 215 for returning the operating knobs 211 and 212 when the operating knobs 211 and 212 are operated.

As illustrated in FIGS. 4A and 4B, the operating knobs 211 and 212 include heads 211a and 212a that receive a depressing operation, flanges 211b and 212b provided in such a manner as to protrude from peripheral edges of surfaces of the heads 211a and 212a which surfaces are on a side opposite to head top surfaces of the heads 211a and 212a, and cylindrical legs 211c and 212c provided in such a manner as to protrude downward from the surfaces of the heads 211a and 212a which surfaces are on the side opposite to the head top surfaces of the heads 211a and 212a.

The knob bezel 213 has a thin plate shape to be fitted to the elongated hole 21e, and has through holes 213a and 213b into which the heads 211a and 212a of the operating knobs 211 and 212 are inserted and which are for exposing the heads 211a and 212a to the outside. The through holes 213a and 213b have a size larger than that of the heads 211a and 212a but smaller than that of the flanges 211b and 212b.

Moreover, through holes 21ea and 21eb, that are larger than the diameter of the legs 211c and 212c of the operating knobs 211 and 212 but smaller than the diameter of the coil springs 214 and 215, are formed in a bottom of the elongated hole 21e of the pen tip side casing 21.

The side switch operator 21SW is attached to the pen tip side casing 21 as follows. That is, in a state in which the coil springs 214 and 215 are fitted in such a manner as to cover the respective peripheries of the legs 211c and 212c of the operating knobs 211 and 212, the legs 211c and 212c of the operating knobs 211 and 212 are respectively inserted into the through holes 21ea and 21eb of the elongated hole 21e of the pen tip side casing 21. The knob bezel 213 is then disposed in such a manner as to be fixed to the elongated hole 21e of the pen tip side casing 21 by bonding or the like when the heads 211a and 212a of the operating knobs 211 and 212 are inserted in the through holes 213a and 213b.

When the side switch operator 21SW is attached to the pen tip side casing 21, the operating knobs 211 and 212 are elastically displaced by the coil springs 214 and 215 in such a manner as to be pushed up to the side of the heads 211a and 212a at all times. In this case, in the present embodiment, the length of the legs 211c and 212c of the operating knobs 211 and 212 is such a length that the switch driving operator 32 of the electronic pen main body 3 can be driven to seesaw by depressing the operating knobs 211 and 212 against the elastic displacement forces of the coil springs 214 and 215. However, the length of the legs 211c and 212c of the operating knobs 211 and 212 in this attachment state is such a length that the legs 211c and 212c do not protrude into the hollow portion of the pen tip side casing 21.

Hence, even in a case where a difference between the inside diameter of the hollow portion and the outside diameter of the electronic pen main body 3 is reduced to make the pen tip side casing 21 as thin as possible, when the electronic pen main body 3 is inserted into the hollow portion of the pen tip side casing 21, the electronic pen main body 3 can be inserted smoothly without being obstructed by distal ends of the legs 211c and 212c.

When the electronic pen main body 3 is inserted in the hollow portion of the pen tip side casing 21 to which the side switch operator 21SW is thus attached and the second contact 312 is fitted to the opening 21b, the legs 211c and 212c of the operating knobs 211 and 212 of the side switch operator 21SW are located on the switch driving operator 32 of the electronic pen main body 3, as illustrated in FIG. 4B.

Hence, when the user depresses the head 211a of the operating knob 211 of the side switch operator 21SW against the elastic displacement force of the coil spring 214, the leg 211c of the operating knob 211 inserted in the through hole 21ea of the elongated hole 21e of the pen tip side casing 21 depresses the leg 32a side of the switch driving operator 32 of the electronic pen main body 3, and thereby turns on and/or off the switch 33. In addition, when the user depresses the head 212a of the operating knob 212 of the side switch operator 21SW against the elastic displacement force of the coil spring 215, the leg 212c of the operating knob 212 inserted in the through hole 21eb of the elongated hole 21e of the pen tip side casing 21 depresses the leg 32b side of the switch driving operator 32 of the electronic pen main body 3, and thereby turns on and/or off the switch 34.

### Example of Internal Configuration of Electronic Pen Main Body 3

FIGS. 5A and 5B are diagrams explaining an example of an internal configuration of the electronic pen main body 3. FIGS. 5A and 5B are sectional views of a state in which the electronic pen main body 3 is housed in the pen tip side casing 21. FIG. 5A is a sectional view of the pen tip side of the position of the side switch operator 21SW. FIG. 5B is a sectional view of the rear end side of the position of the side switch operator 21SW. Incidentally, a sectional view of a positional part provided with the side switch operator 21SW is as illustrated in FIG. 4B, and will therefore be omitted here.

As illustrated in FIG. 5B, the terminal 31 on the rear end side of the electronic pen main body 3 has a structure in which the first contact 311 exposed on the circular end surface on the rear end side and the second contact 312 formed by a flange-shaped portion are coupled to each other via an insulator 313 formed of resin, for example. A side circumferential surface of the terminal 31 from the flange-shaped portion of the second contact 312 to the first contact 311 is covered by an insulator 314 in a tubular shape.

As also described above, the flange-shaped portion of the second contact 312 which flange-shaped portion protrudes in a ring shape from the side circumferential surface of the main body casing 3K is fitted to the step 21d provided in the opening 21b (not illustrated in FIGS. 5A and 5B) on the rear end side of the pen tip side casing 21. Thus, the electronic pen main body 3 is stopped from moving to the pen tip side in the axial direction in the pen tip side casing 21, and is locked in a state of being housed in the pen tip side casing 21.

A rechargeable secondary battery 36 is provided in the electronic pen main body 3, as illustrated in FIG. 5B, and a charging circuit (not illustrated in FIGS. 5A and 5B) is provided on the circuit board 35. The first contact 311 and the second contact 312 of the electronic pen main body 3 are contacts connected to a positive side terminal and a negative side terminal (grounding terminal) of a charging terminal formed by the additional unit 4. In the present embodiment, the first contact 311 is a contact connected to the positive side terminal, and the second contact 312 is a contact connected to the grounding terminal. Further, on the circuit board 35, the first contact 311 is connected to a conductor pattern to which the positive side of the charging terminal is to be connected, and the second contact 312 is connected to a grounding conductor pattern.

In the present embodiment, as described above, the main body casing 3K is formed of a conductive metal, and the second contact 312 as a flange-shaped portion and the main body casing 3K are electrically coupled to each other. The potential of the main body casing 3K is a ground potential.

The circuit board 35 is held by a board holder 37 formed of an insulative material, for example, resin. The board holder 37 has a boat-like shape with the axial direction of the main body casing 3K as a longitudinal direction thereof. As illustrated in FIG. 5A, a pen pressure detector support 371 is provided on the pen tip side in the longitudinal direction of the board holder 37, and a board support 372 is formed on the board holder 37.

The pen pressure detector support 371 is formed in a cylindrical shape. As illustrated in FIG. 5A, a pen pressure detector 6 is held in an internal hollow space of the part formed in the cylindrical shape. The pen pressure detector 6 is configured to detect a displacement in the axial direction of the core body according to a pen pressure applied to a distal end of the core body 5, as a change in capacitance in the present example. The pen pressure detector 6 in the present example is constituted by a configuration that changes in capacitance as a result of a change in a contact area between a dielectric 61 and a conductive elastic member 62 according to the applied pressure (see JP2016/126503, for example). Incidentally, the pen pressure detector 6 that detects the pen pressure on the basis of the capacitance may be a semiconductor device in which a distance between two contacts facing each other with an air layer as a dielectric interposed therebetween changes according to the applied pressure (see JP2013/161307, for example).

As illustrated in FIG. 5A, in the present embodiment, the pen pressure applied to the core body 5 is configured to be transmitted to the pen pressure detector 6 via a pen pressure transmitting member 7. That is, in the present embodiment, a pen pressure transmitting member holder 38 formed of an insulative material, for example, resin, is provided on the pen tip side of the pen pressure detector support 371 of the board holder 37 in a hollow portion of the main body casing 3K of the electronic pen main body 3. The pen pressure transmitting member 7 is held by the pen pressure transmitting member holder 38 in such a manner as to be movable in the axial direction.

Moreover, in the axial direction, the core body 5 is detachably fitted to the pen tip side of the pen pressure transmitting member 7, and the rear end side of the pen pressure transmitting member 7 is fitted to a pressing member 63 that presses the conductive elastic member 62 of the pen pressure detector 6 in the axial direction. A returning coil spring 64 for returning a positional relation in the axial direction between the dielectric 61 and the conductive elastic member 62 to an original state when the pen pressure is removed is provided between the pressing member 63 and the dielectric 61.

Moreover, in the present embodiment, the pen pressure transmitting member 7 is formed of a conductive material, and though not illustrated in the figure, the conductive core body 5 is configured to be electrically coupled to a conductor pattern on the circuit board 35 via the pen pressure transmitting member 7.

Further, in the present embodiment, as illustrated in FIG. 5A, an outer circumference on the pen tip side of the pen pressure transmitting member holder 38 is provided with a peripheral electrode 8. The peripheral electrode 8 is provided in such a manner as to cover a periphery on the pen tip side of the pen pressure transmitting member holder 38 in a state in which the peripheral electrode 8 is insulated from the main body casing 3K by a ring-shaped protrusion 38a provided to an outer circumferential surface of the pen pressure transmitting member holder 38 and further constitute an extension of the main body casing 3K on the pen tip side.

The peripheral electrode 8 is formed in a tubular shape by a material having conductivity, for example, a conductive metal. The peripheral electrode 8 is disposed in such a manner as to enclose a part of the core body 5 excluding a distal end thereof, the core body 5 constituting a central electrode having conductivity. In the present example, the peripheral electrode 8 plays a role of a contact that receives a signal from a position detecting sensor side. Moreover, in the present example, the peripheral electrode 8 has a tapered shape tapered off toward the pen tip, and is configured such that a maximum value of the outside diameter of the peripheral electrode 8 is equal to the outside diameter of the main body casing 3K.

In addition, in the present embodiment, as illustrated in FIG. 5A, a pen tip side cap member 39 formed of a material that is an insulative material and has elasticity is provided in such a manner as to be inserted between the peripheral electrode 8 and the core body 5 in a state in which the pen tip side cap member 39 allows movement of the core body 5 in the axial direction. In this case, as illustrated in FIG. 5A, the core body 5 has a large-diameter portion at a distal end and a small-diameter portion on the rear end side of the distal end. The pen tip side cap member 39 is configured to have a step conforming to the large-diameter portion and the small-diameter portion of the core body 5, and is configured such that a space (air layer) 39a is formed in the vicinity of a coupled portion of the small-diameter portion coupled to the large-diameter portion. The presence of the part of the space 39a renders the core body 5 movable in the axial direction.

A signal (electric field) radiated from the large-diameter portion of a pen tip of the core body 5 is radiated relatively efficiently. However, the radiation of a signal (electric field) from the small-diameter portion of the core body 5 is suppressed due to the action of the space 39a and the pen tip side cap member 39. This is because the space 39a and the pen tip side cap member 39 are different from each other in dielectric constant, and this part functions like a double capacitor. Thus, even when the electronic pen 1 is inclined with respect to an input surface of the position detecting sensor, an excellent signal that does not become broader than necessary can be sent out from the core body 5.

In addition, in the present embodiment, due to the presence of the pen tip side cap member 39, the core body 5 is configured to be movable in the axial direction in a state in which movement thereof in a direction intersecting the axial direction is regulated. It is therefore possible to reduce rattling of the distal end of the core body 5, thereby appropriately transmit the pen pressure applied to the core body 5 to the pen pressure detector 6 through the pen pressure transmitting member 7, and thus appropriately detect the pen pressure by the pen pressure detector 6.

As illustrated in FIGS. 5A and 5B, in the present embodiment, in a state in which the electronic pen main body 3 is housed in the pen tip side casing 21 and the second contact 312 is fitted to the step 21d on the opening 21b side, not only the distal end of the core body 5 but also the taper-shaped distal end of the peripheral electrode 8 protrude to the outside from the opening 21a of the pen tip side casing 21. Incidentally, as described earlier, the core body 5 is detachable from the pen pressure transmitting member 7, and is therefore replaceable.

The board support 372 has a board mounting surface obtained by cutting away a half circumference or more of a cylindrical part and forming a surface thereof after the cutting away into a planar shape on the rear end side of the pen pressure detector support 371. The circuit board 35 is mounted and held on the board mounting surface of the board support 372.

The circuit board 35 in the present example is formed in an elongated rectangular plate shape. Provided on a board surface of the circuit board 35 are switches 33 and 34, as described earlier, as well as a signal generating circuit and a charging circuit. Further, formed on the circuit board 35 are conductive patterns for electrically connecting the pen pressure transmitting member 7 electrically coupled to the core body 5, the pen pressure detector 6, the secondary battery 36, the first contact 311 and the second contact 312 of the terminal 31, and the like to electronic parts on the board surface.

### Example of Configuration of Additional Unit 4 and Example of Structure for Housing Additional Unit 4 in Rear End Side Casing 22

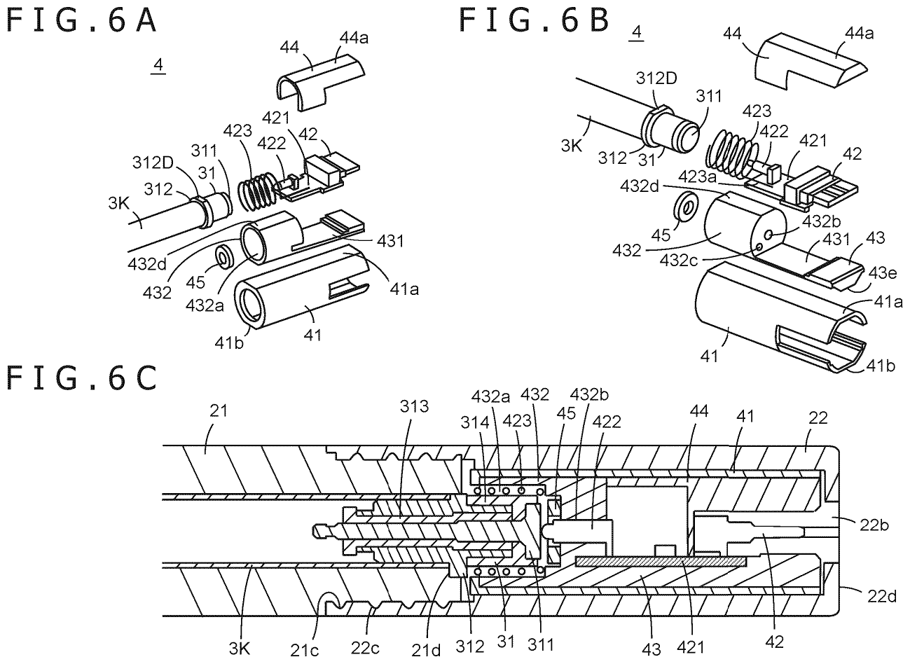

FIGS. 6A and 6B are exploded perspective views of the additional unit 4. FIG. 6A is an exploded perspective view of the additional unit 4 as viewed from the pen tip side. FIG. 6B is an exploded perspective view of the additional unit 4 as viewed from the rear end side. Incidentally, FIG. 6A and FIG. 6B are slightly different from each other in scale for convenience. In addition, FIG. 6C is a fragmentary sectional view of the rear end side casing 22 and the pen tip side casing 21 screwed to each other in a state in which the additional unit 4 is housed in the rear end side casing 22.

As illustrated in FIGS. 6A, 6B, and 6C, in the present embodiment, the additional unit 4 is configured such that the USB connector 42 is held and housed in a connector holder 43 in an additional unit casing 41.

The additional unit casing 41 is formed by a tubular body formed of an insulative member, for example, resin. As illustrated in FIG. 1A, FIG. 2A, FIG. 3A, and FIG. 6C, the length in the axial direction of the additional unit casing 41 is shorter than the length in the axial direction of the rear end side casing 22. Moreover, in the present embodiment, as illustrated in FIG. 1A, FIG. 2A, FIG. 3A, and FIGS. 6A and 6B, a plane 41a and a plane 41b are formed from one end to another end in the axial direction separated from each other by 180 degrees in a side circumferential surface of the additional unit casing 41. The plane 41a and the plane 41b in the present embodiment have a flat surface not only in an outer peripheral side surface of the additional unit casing 41 but also in an inner wall surface thereof.

On the other hand, as illustrated in FIG. 1A and FIG. 3C, planes 22ea and 22eb to be engaged with the planes 41a and 41b of the additional unit casing 41 are formed and separated from each other by 180 degrees in an inner wall surface of the rear end side casing 22. When the additional unit casing 41 is inserted and housed in the rear end side casing 22, the planes 41a and 41b of the additional unit casing 41 and the inner wall surface planes 22ea and 22eb of the rear end side casing 22 are engaged with each other. The additional unit casing 41 is thereby set in a state of being unable to rotate about the axial direction with respect to the rear end side casing 22 in the rear end side casing 22.

As illustrated in FIGS. 6A and 6B, the USB connector 42 has the connector terminal plate 42a formed by arranging, on a flat surface, a terminal group including two terminals for receiving a charging voltage from the outside. The USB connector 42 is disposed on a surface of a circuit board 421 parallel with the flat surface of the connector terminal plate 42a. A pair of conductive patterns, to which the two terminals for receiving the charging voltage on the USB connector 42 are electrically coupled, is formed on the circuit board 421. Moreover, the circuit board 421 is provided with a connection terminal pin 422 electrically coupled to one of the pair of conductive patterns, the connection terminal pin 422 being formed by a pogo pin, for example. In addition, one end of a conductive coil spring 423 formed of a conductive metal is electrically coupled to the other of the pair of conductive patterns of the circuit board 421. The conductive coil spring 423 has an inside diameter larger than the outside diameter of the terminal 31 of the electronic pen main body 3 and has an outside diameter substantially equal to the outside diameter of the flange-shaped portion of the second contact 312 of the terminal 31.

The connection terminal pin 422 and the conductive coil spring 423 constitute terminals for supplying the charging voltage received from the outside by the USB connector 42 to the charging circuit of the electronic pen main body 3. In the present example, the connection terminal pin 422 is a positive electrode terminal, and the conductive coil spring 423 is a negative electrode terminal (grounding terminal).

The connector holder 43 includes a connector mounting and holding surface 431 on which the USB connector 42 is mounted and held and a connection fitting 432 into which the terminal 31 of the electronic pen main body 3 is inserted to be electrically coupled to the USB connector 42.

As illustrated in FIG. 6C, the circuit board 421 to which the USB connector 42 is electrically coupled and fastened is mounted and held on the connector mounting and holding surface 431.

Moreover, as illustrated in FIG. 6C, an upper portion of the connector mounting and holding surface 431 is configured to be covered by a cover part 44. As illustrated in FIGS. 6A and 6B, a plane 44a is formed in an upper portion of the cover part 44, the plane 44a being parallel with the flat surface of the connector terminal plate 42a of the USB connector 42 and being formed in such a manner as to be engaged with the inner wall side of the plane 41a of the additional unit casing 41. Moreover, a plane 43e is formed on the bottom side of the connector holder 43 which bottom side is opposite to the plane 44a in such a manner as to be parallel with the plane 44a, such that the plane 43e is engaged with the inner wall side of the plane 41b of the additional unit casing 41.

As illustrated in FIG. 6A, the connection fitting 432 includes a fitting recess 432a that has an opening on a side for coupling to the terminal 31 of the electronic pen main body 3. The inside diameter of the fitting recess 432a is larger than the outside diameter of the conductive coil spring 423. As illustrated in FIG. 6C, the conductive coil spring 423 is housed in the fitting recess 432a.

Through holes 432b and 432c are formed in a wall of the connection fitting 432 on the connector mounting and holding surface 431 side, the wall constituting a bottom of the fitting recess 432a of the connection fitting 432. The through hole 432b is provided in a central position of the bottom of the connection fitting 432. Thus, as illustrated in FIG. 6C, a distal end of the connection terminal pin 422 on the circuit board 421 is configured to protrude into the fitting recess 432a of the connection fitting 432 through the through hole 432b.

Moreover, in the present embodiment, as illustrated in FIG. 6C, the distal end of the connection terminal pin 422 which distal end protrudes into the fitting recess 432a of the connection fitting 432 is provided in such a manner as to be inserted into a through hole of a ring-shaped impact absorbing member 45 formed by an elastic member such as rubber, for example. As illustrated in FIG. 6C, in the present example, the impact absorbing member 45 is provided in such a manner as to be locked to a recess of a bottom of the fitting recess 432a of the connection fitting 432.

In addition, in the present example, the through hole 432c is provided in the bottom of the connection fitting 432 and in the vicinity of the circuit board 421. One end of the conductive coil spring 423 housed in the fitting recess 432a of the connection fitting 432 is inserted through the through hole 432c and reaches the circuit board 421. Moreover, the one end of the conductive coil spring 423 is soldered to a conductive pattern on the circuit board 421. The conductive coil spring 423 is thereby fastened and electrically coupled to the circuit board 421.

Moreover, in the present embodiment, an upper portion of a side circumferential surface of the connection fitting 432 has a plane 432d formed in such a manner as to be flush with the plane 44a of the cover part 44 and engage with the inner wall side of the plane 41a of the additional unit casing 41.

As described above, the connector holder 43 holds the USB connector 42 fitted to the circuit board 421, and holds the connection terminal pin 422 and the conductive coil spring 423 connected with the terminals for receiving the charging voltage on the USB connector 42. Moreover, the connector holder 43 is inserted into the additional unit casing 41 in a state in which the cover part 44 is fitted onto the circuit board 421. The additional unit 4 is thus constructed.

In the additional unit 4, due to the engagement of the plane 41a of the additional unit 4 with the plane 432d of the connector holder 43 and the plane 44a of the cover part 44 and the engagement of the plane 43e on the bottom surface side of the connector holder 43 with the plane 41b of the additional unit 4, the connector holder 43 is in a state of being unable to rotate about the axial direction with respect to the additional unit casing 41 in the additional unit casing 41. That is, the USB connector 42 is housed in the additional unit casing 41 in a state in which the USB connector 42 is unable to rotate about the axial direction with respect to the additional unit casing 41.

This additional unit 4 is inserted from the opening 22a on the pen tip side of the rear end side casing 22, and is housed in the rear end side casing 22. In this case, the planes 41a and 41b of the additional unit casing 41 are engaged with the planes 22ea and 22eb (see FIG. 3C) formed in a hollow portion of the rear end side casing 22, and the additional unit 4 is housed in a state of being unable to rotate about the axial direction with respect to the rear end side casing 22. In this state, the longitudinal direction of the opening 22b as an elongated hole of the lid 22d on the rear end side of the rear end side casing 22 and the plate surface direction of the terminal plate 42a of the USB connector 42 coincide with each other, and an external connector can be connected to the USB connector 42 from the opening 22b of the rear end side casing 22.

The rear end side casing 22 in which the additional unit 4 is housed as described above is screwed onto the rear end side of the pen tip side casing 21 in which the electronic pen main body 3 is housed. The electronic pen 1 is thus constructed. In the electronic pen 1, the terminal 31 of the electronic pen main body 3 protruding from the rear end side of the pen tip side casing 21 is inserted into the connection fitting 432 of the additional unit 4 in the rear end side casing 22, the first contact 311 of the terminal 31 and the connection terminal pin 422 are electrically coupled to each other, and the second contact 312 and the conductive coil spring 423 are electrically coupled to each other. In this case, the first contact 311 of the terminal 31 has a circular end surface centered at the central position of the cross section of the electronic pen outer casing 2, and the connection terminal pin 422 is provided at substantially the central position of the cross section of the electronic pen outer casing 2. Further, the conductive coil spring 423 is connected to the ring-shaped second contact 312 of the terminal 31. Thus, alignment for the two electric connection parts is unnecessary.

Moreover, in the electronic pen 1, the second contact 312 of the terminal 31 is electrically coupled by the conductive coil spring 423, and the first contact 311 and the connection terminal pin 422 are electrically coupled to each other with the ring-shaped impact absorbing member 45 interposed therebetween. Hence, even when the electronic pen 1 falls and an impact load is applied to the core body 5, for example, the impact can be absorbed due to the presence of the impact absorbing member 45.

### Description of Example of Electric Configuration of Electronic Pen 1

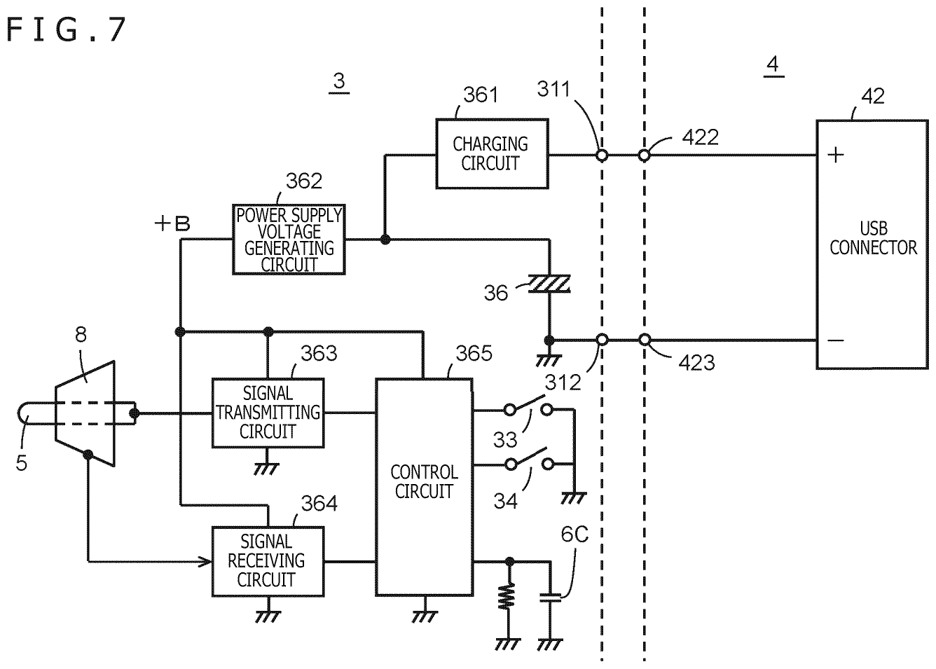

An electric configuration of the electronic pen 1 is as illustrated in FIG. 7. As illustrated in FIG. 7, in the additional unit 4, the connection terminal pin 422 is connected to a power receiving terminal of the USB connector 42 which power receiving terminal receives the charging voltage, and the conductive coil spring 423 is connected to a grounding terminal of the USB connector 42.

Moreover, in the electronic pen main body 3, the first contact 311 of the terminal 31 is connected to an input terminal of a charging circuit 361. An output terminal of the charging circuit 361 is connected to an input terminal of a power supply voltage generating circuit 362, and is also connected to a positive electrode terminal of the secondary battery 36. The charging circuit 361 charges the secondary battery 36 by supplying the secondary battery 36 with a charging current based on the charging voltage input from the USB connector 42 through the connection terminal pin 422 and the first contact 311.

The power supply voltage generating circuit 362 receives the voltage of the secondary battery 36, and generates a power supply voltage +B. The generated power supply voltage +B is supplied to a signal transmitting circuit 363, a signal receiving circuit 364, and a control circuit 365. In the present example, the control circuit 365 is connected with a variable capacitance capacitor 6C formed by the pen pressure detector 6. The control circuit 365 detects a pen pressure value from the capacitance of the variable capacitance capacitor 6C.

The signal transmitting circuit 363 includes an oscillating circuit having a predetermined frequency. The signal transmitting circuit 363 generates a signal under control of the control circuit 365, and transmits the signal to the position detecting sensor by capacitive coupling through the core body 5 as the central electrode. The signal transmitted from the signal transmitting circuit 363 includes a position detection signal and a pen pressure value information signal. The position detection signal is transmitted as a burst signal of a predetermined frequency. As for the pen pressure value information, in the present example, the pen pressure value is converted into a binary digital signal, and the binary digital signal is transmitted as an amplitude shift keying (ASK) modulated signal or an on off keying (OOK) modulated signal, for example.

The peripheral electrode 8 receives a signal from the position detecting sensor by capacitive coupling, and supplies the signal to the control circuit 365. The control circuit 365 controls a timing of output of the signal from the signal transmitting circuit 363 at a timing based on the signal received from the position detecting sensor.

### Effects Produced by Electronic Pen 1 according to Embodiment

As described above, the electronic pen 1 according to the foregoing embodiment is constituted by four unit parts, that is, the pen tip side casing 21, the rear end side casing 22, the electronic pen main body 3, and the additional unit 4, and is configured to be capable of being assembled by use of these four unit parts. Hence, when one of the four unit parts is damaged or faulty, the electronic pen 1 can be repaired by replacing only the damaged or faulty unit part.

In addition, in the electronic pen 1 according to the foregoing embodiment, the core body 5 is configured to be supported by the pen tip side of the electronic pen main body 3. The pen tip side opening of the pen tip side casing 21 of the electronic pen outer casing 2 therefore does not need to be configured to support the core body 5. Thus, the pen tip side casing 21 does not need to be designed in consideration of the diameter of the core body 5 or the like. The pen tip side casing 21 is consequently increased in degree of freedom of design and, in turn, a degree of freedom of design of the electronic pen outer casing 2 can be increased.

In addition, in the electronic pen 1 according to the present embodiment, when the pen tip side casing 21 and the rear end side casing 22 are coupled to each other, the electronic pen main body 3 and the additional unit 4 are elastically coupled to each other securely, and are also electrically coupled to each other securely. Moreover, in the electronic pen 1 according to the present embodiment, because a D-cut shape portion 312D of the second contact 312 of the terminal 31 is used, the electronic pen main body 3 is housed in the electronic pen outer casing 2 in a state in which the electronic pen main body 3 is unable to rotate in the axial direction with respect to the pen tip side casing 21. Hence, this configuration can prevent one-sided wear of the core body 5 in the electronic pen 1.

Further, in the present embodiment, through use of the D-cut shape portion 312D of the second contact 312 of the electronic pen main body 3, it is possible to non-rotatably house the electronic pen main body 3 in the electronic pen outer casing 2 and perform alignment such that the side switch operator 21SW of the pen tip side casing 21 is located directly above the switch driving operator 32 of the electronic pen main body 3.

Moreover, in the electronic pen 1 according to the present embodiment, as for a configuration to this end, it suffices only to form the shape of the second contact of the terminal of the electronic pen into a D-cut shape and form the opening 22b on the rear end side of the pen tip side casing 21 into a corresponding D-cut shape. The configuration can therefore be realized by a simple configuration.

### MODIFICATIONS

### Example 1

In the electronic pen 1 according to the foregoing embodiment, the second contact 312 of the terminal 31 of the electronic pen main body 3 has the D-cut shape portion 312D, and the opening 21b on the rear end side of the pen tip side casing 21 has a shape matched to the D-cut shape portion 312D of the second contact 312. Thus, the electronic pen main body 3 is made non-rotatable with respect to the pen tip side casing 21, and alignment for the side switch is performed. However, a configuration for setting the electronic pen main body 3 in a non-rotatable state with respect to the pen tip side casing 21 and performing alignment for the side switch is not limited to the configuration using the D-cut shapes.

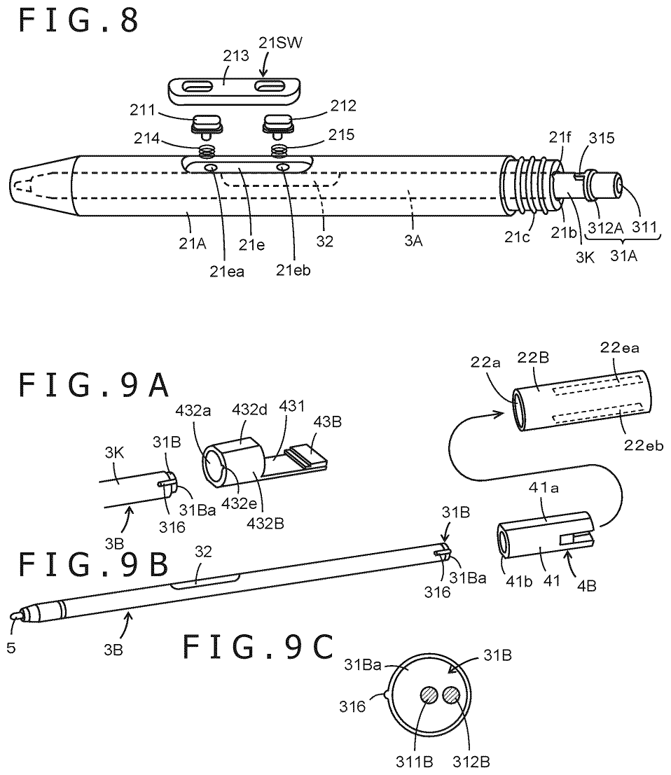

FIG. 8 represents an example of such a modification. Of parts corresponding to constituent portions of the electronic pen main body 3 and the pen tip side casing 21 in the foregoing embodiment, parts having identical configurations are identified by the same reference characters, and parts having different configurations are indicated by the same reference characters with a suffix “A” attached thereto.

Specifically, in the example illustrated in FIG. 8, a terminal 31A on the rear end side of an electronic pen main body 3A includes a ring-shaped second contact 312A not having the D-cut shape portion 312D, in place of the ring-shaped second contact 312 having the D-cut shape portion 312D. There is also a ridge (or a protrusion) 315 protruding outward from an external side circumferential surface of the main body casing 3K is provided integrally with the ring-shaped second contact 312A (or the ridge 315 may be separate from the second contact 312A). The ridge 315 is provided at a position on the pen tip side of the second contact 312A and at a predetermined angular position in the circumferential direction of the external side circumferential surface of the main body casing 3K.

In addition, on a pen tip side casing 21A side, as illustrated in FIG. 8, the inner wall surface of the opening 21b in a rear end of the pen tip side casing 21A is provided with a recessed groove 21f into which the ridge 315 on the electronic pen main body 3A side is fitted (or a recess into which the protrusion is fitted). Further, the electronic pen main body 3A is inserted into the pen tip side casing 21A, and the ridge 315 on the electronic pen main body 3A side is fitted into the recessed groove 21f on the pen tip side casing 21A side, so that the two are coupled to each other. The electronic pen main body 3A is thereby housed and locked in the pen tip side casing 21A in a state in which the electronic pen main body 3A is non-rotatable with respect to the pen tip side casing 21A.

In this case, as illustrated in FIG. 8, the formation positions of the ridge 315 on the electronic pen main body 3A side and the recessed groove 21f on the pen tip side casing 21A side are positions at which the switch driving operator 32 of the electronic pen main body 3A and the side switch operator 21SW of the pen tip side casing 21A are aligned with each other. That is, in the case of the example of FIG. 8, as a result of the fitting of the ridge 315 on the electronic pen main body 3A side into the recessed groove 21f on the pen tip side casing 21A side, the electronic pen main body 3A is housed in the pen tip side casing 21A in a state in which the electronic pen main body 3A is non-rotatable with respect to the pen tip side casing 21A, and the switch driving operator 32 of the electronic pen main body 3A and the side switch operator 21SW of the pen tip side casing 21A are aligned with each other.

Incidentally, while, in the example of FIG. 8, the ridge 315 is provided to the external side circumferential surface of the main body casing 3K of the electronic pen main body 3, and the recessed groove 21f is formed in an inner wall surface of the pen tip side casing 21, a protrusion may be provided in place of the ridge, and a recess may be provided in place of the recessed groove. In addition, a ridge (or a protrusion) may be provided to an inner wall surface of the pen tip side casing 21A, and a recessed groove (or a recess into which the protrusion is fitted) may be formed in the external side circumferential surface of the main body casing 3K of the electronic pen main body 3A.

### Example 2

In the electronic pen 1 according to the foregoing embodiment, the electronic pen main body 3 is configured to be non-rotatable with respect to the pen tip side casing 21 in order to set the electronic pen main body 3 in a non-rotatable state with respect to the electronic pen outer casing 2. However, the electronic pen main body 3 can be made non-rotatable with respect to the electronic pen outer casing 2 by setting the electronic pen main body 3 in a non-rotatable state with respect to the rear end side casing 22.

FIGS. 9A to 9C represent an example of such a configuration. Of parts corresponding to constituent portions of the electronic pen main body 3 and the pen tip side casing 21 in the foregoing embodiment, parts having identical configurations are identified by the same reference characters, and parts having different configurations are indicated by the same reference characters with a suffix “B” attached thereto.

FIG. 9A illustrates a terminal 31B on the rear end side of an electronic pen main body 3B as a principal part in the present example and a connector holder 43B of the additional unit 4. FIG. 9B illustrates the electronic pen main body 3B, an additional unit 4B, and a rear end side casing 22B. FIG. 9C illustrates an example of a configuration of the terminal 31B of an end surface when the rear end side of the electronic pen main body 3B in the present example is viewed from the axial direction.

In the example of FIGS. 9A to 9C, the terminal 31B on the rear end side of the electronic pen main body 3B has a first contact 311B and a second contact 312B formed side by side in a circular end surface 31Ba on the rear end side of the electronic pen main body 3B, as illustrated in FIG. 9C. In the present example, the first contact 311B is provided at a central position of the circular end surface 31Ba on the rear end side of the electronic pen main body 3B.

Though not illustrated in the figure, the voltage terminal and the grounding terminal of the USB connector 42 on the additional unit 4B side are provided with two pogo pins arranged side by side to be electrically coupled to the first contact 311B and the second contact 312B of the terminal 31B. In this case, the pogo pins are arranged side by side such that the pogo pin to which the voltage terminal of the USB connector 42 is connected is disposed in such a manner as to be connected to the first contact 311B provided at the central position of the circular end surface 31Ba on the rear end side of the electronic pen main body 3B and such that the pogo pin to which the grounding terminal of the USB connector 42 is connected is connected to the second contact 312B.

Moreover, in the example of FIGS. 9A to 9C, as illustrated in FIG. 9A, the outer circumference of the electronic pen main body 3B that is inserted into a connection fitting 432B of the connector holder 43B of the additional unit 4B is provided with a ridge 316 (or a protrusion) at a predetermined angular position in the circumferential direction of the outer circumference. In addition, an inner wall surface of the connection fitting 432B of the connector holder 43B of the additional unit 4B is provided with a recessed groove 432e into which the ridge 316 (or the protrusion) of the electronic pen main body 3B is fitted (or a recess into which the protrusion is fitted).

In this case, an angular position in the circumferential direction, at which angular position the ridge 316 on the electronic pen main body 3B side and the recessed groove 432e of the connection fitting 432B of the connector holder 43B are formed, is configured to be a position at which the first contact 311B and the second contact 312B of the terminal 31B of the electronic pen main body 3B are electrically coupled to the two pogo pins connected with the voltage terminal and the grounding terminal of the USB connector 42 on the additional unit 4B side.

Further, as illustrated in FIG. 9B, a rear end part of the electronic pen main body 3B, in which rear end part the terminal 31B is formed, is inserted into the connection fitting 432 of the connector holder 43 housed in the additional unit casing 41 of the additional unit 4B. The ridge 316 on the electronic pen main body 3B side and the recessed groove 432e of the connection fitting 432B of the connector holder 43B are coupled to each other such that the ridge 316 is fitted into the recessed groove 432e. Then, when the first contact 311B and the second contact 312B of the terminal 31B of the electronic pen main body 3B are electrically coupled to the two pogo pins connected with the voltage terminal and the grounding terminal of the USB connector 42 on the additional unit 4B side, the electronic pen main body 3B is coupled to the additional unit casing 41 in a state in which the electronic pen main body 3B is non-rotatable with respect to the additional unit casing 41.

As described earlier, the additional unit casing 41 is housed in the rear end side casing 22B in a state in which the additional unit casing 41 is non-rotatable with respect to the rear end side casing 22B. Hence, the electronic pen main body 3B is locked to the rear end side casing 22B in a state in which the electronic pen main body 3B is made non-rotatable with respect to the rear end side casing 22B.

Then, the rear end side casing 22B to which the electronic pen main body 3B is thus locked is screwed onto a pen tip side casing 21B. The electronic pen main body 3B can thereby be made non-rotatable with respect to an electronic pen outer casing 2B.

In the case of the example of FIGS. 9A to 9C, with the foregoing configuration as it is, the electronic pen main body 3B is locked to the rear end side casing 22B, and a positional relation in the circumferential direction between the electronic pen main body 3B and the pen tip side casing 21B is not a specific positional relation. Therefore, alignment between the switch driving operator 32 of the electronic pen main body 3B and the side switch operator 21SW of the pen tip side casing 21B cannot be performed in this state.

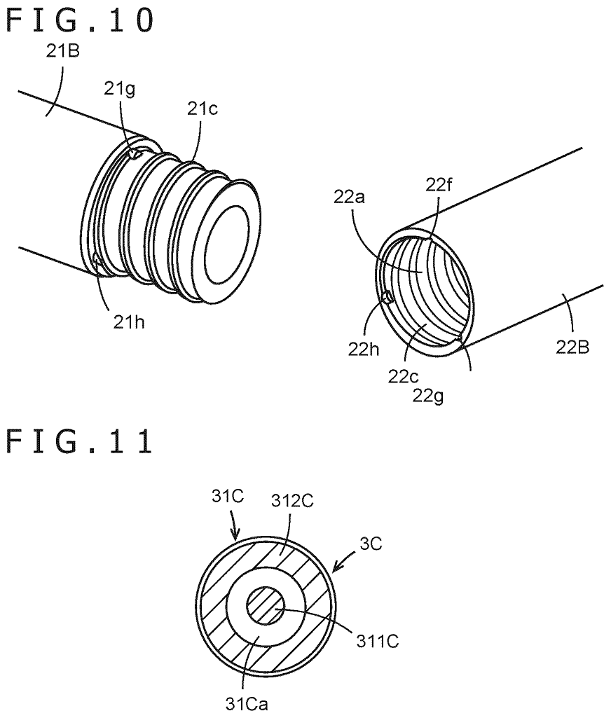

In view of this, in the present example, as illustrated in FIG. 10, a base on the pen tip side of the threaded surface 21c of the pen tip side casing 21B is provided with one or a plurality of protrusions, or three protrusions 21g, 21h, and 21i (protrusion 21i is not illustrated) in the present example. A distal end of the threaded surface 22c of the rear end side casing 22B is provided with recesses 22f, 22g, and 22h to be fitted with the protrusions 21g, 21h, and 21i. In this case, the positions in the circumferential direction of the plurality of protrusions and the corresponding recesses are positions not at equal angular intervals. For example, the positions of the three protrusions 21g, 21h, and 21i and the three recesses 22f, 22g, and 22h are such positions that a shape obtained by connecting these positions to one another is not a regular triangle.

In the case of such a configuration, when the rear end side casing 22B to which the electronic pen main body 3B is locked as described above is screwed onto the pen tip side casing 21, the protrusions 21g, 21h, and 21i and the recesses 22f, 22g, and 22h are fitted to each other in a final stage of the screwing. Then, the screwing is stopped, and the protrusions 21g, 21h, and 21i and the recesses 22f, 22g, and 22h are locked to each other in this state. An electronic pen 1B is thus constituted. In the electronic pen 1B, alignment is performed such that the side switch operator 21SW of the pen tip side casing 21B is located directly above the switch driving operator 32 of the electronic pen main body 3B.

In addition, as a result of this alignment, a specific positional relation to the side switch operator 21SW is set such that, for example, the longitudinal direction of the opening 22b as an elongated hole from which the terminals of the USB connector 42 are exposed on the rear end side of the rear end side casing 22B is an exactly horizontal direction when the side switch operator 21SW of the pen tip side casing 21B is oriented exactly upward, for example.

### Example 3

Incidentally, in the example of FIGS. 9A to 9C, as illustrated in FIG. 9C, the terminal 31B of the electronic pen main body 3B has the first contact 311B and the second contact 312B formed side by side on the circular end surface 31Ba. Thus, the ridge 316 (or the protrusion) formed on a rear end of the electronic pen main body 3B and the recessed groove 432e of the connection fitting 432B of the connector holder 43 are arranged in consideration of the alignment between the first and second contacts 311B and 312B of the terminal 31B and the two pogo pins connected to the terminals of the USB connector 42 on the additional unit 4B side.

However, the terminal of the rear end of the electronic pen main body can be configured such that alignment for the contacts does not need to be taken into consideration, by forming the terminal as in an example of FIG. 11. Incidentally, also in the present example, of parts corresponding to constituent parts of the electronic pen main body 3 and the additional unit 4, parts having identical configurations are identified by the same reference characters, and parts having different configurations will be described with a suffix “C” attached to the same reference characters.

In an electronic pen main body 3C in the present example, as illustrated in FIG. 11, a terminal 31C of the rear end has a first contact 311C formed at a central position of a circular end surface 31Ca of the rear end, and has a second contact 312C formed in such a manner as to be concentric with the first contact 311C and in a ring shape electrically separated from the first contact 311C.

On the other hand, the two pogo pins of the USB connector 42 disposed on the connector holder 43 are arranged side by side as in the case for the electronic pen main body 3B illustrated in FIGS. 9A to 9C. In this case, the pogo pins are arranged side by side such that the pogo pin to which the voltage terminal of the USB connector 42 is connected is disposed in such a manner as to be connected to the first contact 311C provided at the central position of the circular end surface 31Ca on the rear end side of the electronic pen main body 3C, and such that the pogo pin, to which the grounding terminal of the USB connector 42 is connected, is connected to the ring-shaped second contact 312C.

With such a configuration, the first contact 311C is provided at the central position of the circular end surface 31Ca on the rear end side of the electronic pen main body 3C, and is therefore electrically coupled at all times to the pogo pin to which the voltage terminal of the USB connector 42 on the additional unit 4B side is connected, even when the electronic pen main body 3C is rotated and coupled to the additional unit 4B, and the pogo pin, to which the grounding terminal of the USB connector 42 on the additional unit 4B side is connected, is connected to the ring-shaped second contact 312C having the center of the circular end surface 31Ca on the rear end side of the electronic pen main body 3C as a central position thereof, and is therefore electrically coupled to the ring-shaped second contact 312C at all times even when the electronic pen main body 3C is rotated and coupled to the additional unit 4B. Hence, according to the example of FIG. 11, it is not necessary to consider alignment between the two contacts of the electronic pen main body 3C and the two pogo pins of the USB connector 42 disposed on the connector holder 43.

Incidentally, the example of FIG. 11 is also applicable to the terminals 31, 31A, and 31B of the electronic pen main bodies 3, 3A, and 3B described above.

### Example 4

In addition, the coupling of the rear end side casing 22 to the pen tip side casing 21 is not limited to a screwing type as in the foregoing example. For example, one of the pen tip side casing 21 and the rear end side casing 22 can have the other inserted therein, and the two can be locked and fixed to each other by a predetermined locking and fixing section.

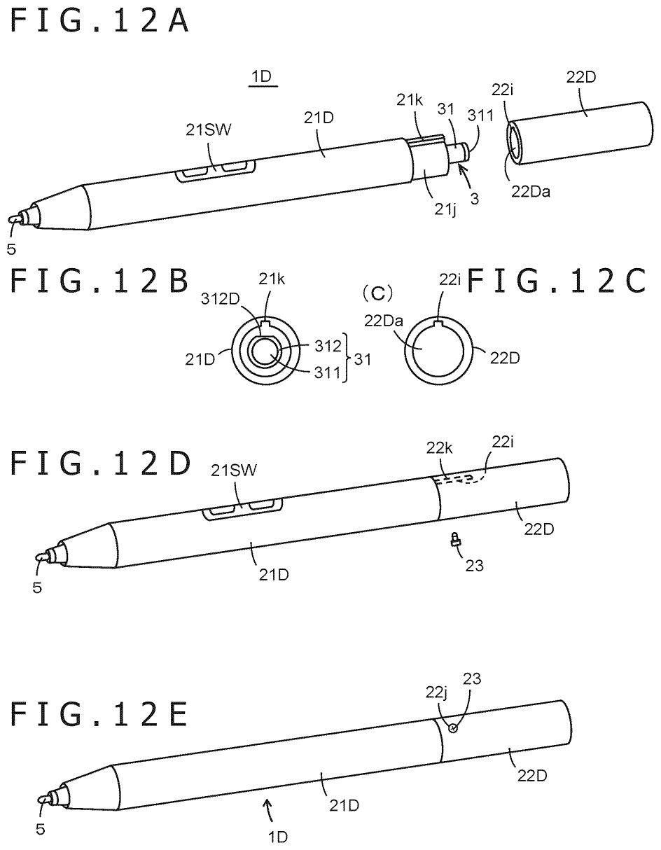

An example of FIGS. 12A to 12E is an example in a case where the coupling of the rear end side casing 22 to the pen tip side casing 21 is thus configured in the electronic pen 1 according to the foregoing embodiment. Incidentally, also in the present example, of parts corresponding to respective constituent portions of the above-described electronic pen 1, parts having identical configurations are identified by the same reference characters, and parts having different configurations will be described with a suffix “D” attached to the same reference characters.

FIG. 12A illustrates a pen tip side casing 21D and a rear end side casing 22D arranged side by side in the axial direction of an electronic pen 1D in the present example, with the electronic pen main body 3 housed and locked in the pen tip side casing 21D, and with the additional unit 4 housed in the rear end side casing 22D. In addition, FIG. 12B is a view of the pen tip side casing 21D, in which the electronic pen main body 3 is housed and locked, as viewed in a direction orthogonal to a circular end surface of a first electrode 311 of the terminal 31 from the circular end surface side. In addition, FIG. 12C is a view of the rear end side casing 22D, in which the additional unit 4 is housed, as viewed in the axial direction from an opening 22Da on the pen tip side. Incidentally, FIG. 12C does not illustrate the additional unit 4 on the inside.

Moreover, FIG. 12D illustrates the electronic pen 1D in a state in which the pen tip side casing 21D and the rear end side casing 22D in FIG. 12A are coupled to each other. In addition, FIG. 12E illustrates a state in which the electronic pen 1D in FIG. 12D is rotated about the axial direction by 180 degrees.

As illustrated in FIGS. 12A and 12B, a small-diameter structure 21j on the rear end side of the pen tip side casing 21D, the small-diameter structure 21j having a diameter slightly smaller than the inside diameter of the rear end side casing 22D, has a ridge 21k (or a protrusion) formed thereon at a predetermined angular position in the circumferential direction of the small-diameter structure 21j. On the other hand, as illustrated in FIGS. 12A and 12C, an inner wall surface on the opening 22Da side on the pen tip side of the rear end side casing 22D has a recessed groove 22i (or a recess to be fitted to the protrusion) formed therein at a predetermined angular position in the circumferential direction of the inner wall surface.

In this case, the ridge 21k of the pen tip side casing 21D and the recessed groove 22i of the rear end side casing 22D in the present example are set such that the long hole direction of an elongated hole 22d on the rear end side of the rear end side casing 22D can be aligned with respect to the position of the side switch operator 21SW of the pen tip side casing 21D, as described in the example of FIG. 10.

Further, when the rear end side casing 22D is pushed onto the small-diameter structure 21Dj of the pen tip side casing 21D in a state in which the ridge 21k of the pen tip side casing 21D and the recessed groove 22i of the rear end side casing 22D are aligned with each other, as illustrated in FIG. 12D, the rear end side casing 22D is coupled to the pen tip side casing 21D, and is locked in the coupled state.

Moreover, in the present example, a locking and fixing section is used to fix the rear end side casing 22D in the state of being coupled to the pen tip side casing 21D. In the present example, a screw (small screw) 23 is used as the locking and fixing section. That is, as illustrated in FIG. 12E, a threaded hole 22j for the screw 23 is provided at a position of the rear end side casing 22D that covers the small-diameter structure 21j of the pen tip side casing 21D at a time of the coupling of the rear end side casing 22D to the pen tip side casing 21D. The screw 23 is screwed in through the threaded hole 22j, and a distal end of the screw 23 abuts against the small-diameter structure 21j of the pen tip side casing 21D. The rear end side casing 22D is thereby locked and fixed to the pen tip side casing 21D.

Incidentally, in the above-described example, a ridge (or a protrusion) is provided on the pen tip side casing 21D side, and a recessed groove (or a recess into which the protrusion is fitted) is provided on the rear end side casing 22D side. Conversely, however, a ridge (or a protrusion) may be provided on the rear end side casing 22D side, and a recessed groove (or a recess into which the protrusion is fitted) may be provided on the pen tip side casing 21D side.

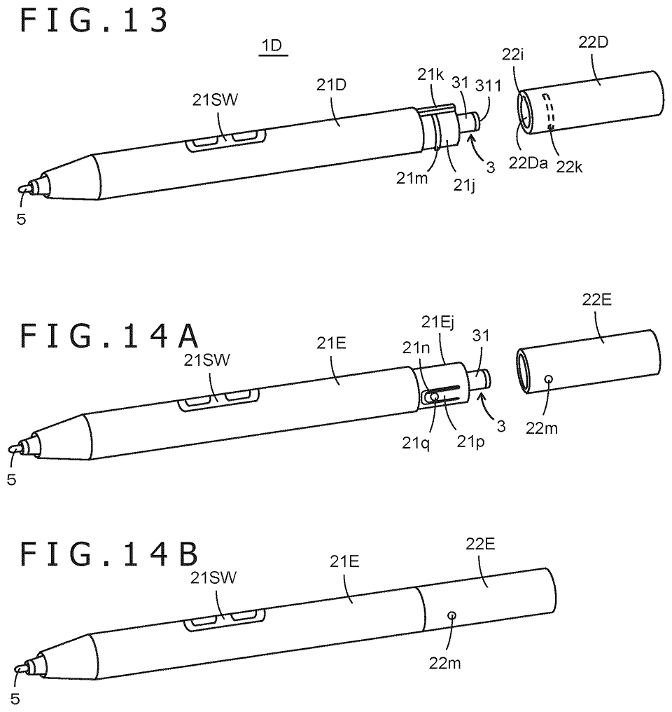

In addition, the locking and fixing section is not limited to the one using the screw 23 as in the above-described example. For example, as illustrated in FIG. 13, a ring-shaped protrusion 21m is provided to the small-diameter structure 21j of the pen tip side casing 21D, and a ring-shaped recess 22k is provided to an inner wall surface of the rear end side casing 22D. In such a manner, when the rear end side casing 22D is coupled to the pen tip side casing 21D, the ring-shaped protrusion 21m of the small-diameter structure 21j of the pen tip side casing 21D and the ring-shaped recess 22k of the inner wall surface of the rear end side casing 22D are fitted to each other, and the coupled state of the pen tip side casing 21D and the rear end side casing 22D is thereby locked and fixed.

In addition, a configuration may be adopted as illustrated in FIGS. 14A and 14B in order to make one of the pen tip side casing 21 and the rear end side casing 22 have the other inserted therein and lock and fix the two to each other by a predetermined locking and fixing section. In the present example, of parts corresponding to respective constituent portions of the above-described electronic pen 1, parts having identical configurations are identified by the same reference characters, and parts having different configurations will be described with a suffix “E” attached to the same reference characters.

FIG. 14A illustrates a pen tip side casing 21E and a rear end side casing 22E arranged side by side in the axial direction of an electronic pen 1E in the present example, with the electronic pen main body 3 housed and locked in the pen tip side casing 21E, and with the additional unit 4 housed in the rear end side casing 22E. In addition, FIG. 14B illustrates the electronic pen 1E in a state in which the pen tip side casing 21E and the rear end side casing 22E in FIG. 14A are coupled to each other.

As illustrated in FIG. 14A, a small-diameter structure 21Ej on the rear end side of the pen tip side casing 21E in the present example has a small thickness. An elastic piece 21p having the axial direction of the pen tip side casing 21E as a longitudinal direction thereof is formed at a predetermined angular position in the circumferential direction of the small-diameter structure 21Ej by forming a U-shaped cut-out portion 21n in the small-diameter structure 21Ej having a small thickness. The elastic piece 21p is elastically displaceable in a direction intersecting the axial direction.

As illustrated in FIG. 14A, a protrusion 21q that protrudes outward from an outer circumferential surface of the small-diameter structure 21Ej is provided at a distal end position in the longitudinal direction of the elastic piece 21p, the distal end position being on the side of a bent portion of the U-shape of the U-shaped cut-out portion 21n.

Moreover, the rear end side casing 22E is provided with a through hole 22m at a position corresponding to the protrusion 21q of the elastic piece 21p when the opening 22a side of the rear end side casing 22E is coupled in the axial direction in such a manner as to cover the small-diameter structure 21Ej of the pen tip side casing 21E. In this case, as in the example of FIGS. 12A to 12E, the formation position of the elastic piece 21p and the formation position of the through hole 22m are set such that the long hole direction of the elongated hole 22d on the rear end side of the rear end side casing 22D can be aligned with respect to the position of the side switch operator 21SW of the pen tip side casing 21D, as described in the example of FIG. 10.

When the rear end side casing 22E is pushed onto the small-diameter structure 21Ej of the pen tip side casing 21D configured as described above, as illustrated in FIG. 14B, the rear end side casing 22E is coupled to the pen tip side casing 21E. In this state, the elastic piece 21p of the small-diameter structure 21Ej of the pen tip side casing 21E is elastically displaced to the hollow portion side of the pen tip side casing 21E by an amount corresponding to the protrusion 21q.

Further, in the present example, in this coupled state, when the rear end side casing 22E is rotated in the axial direction with respect to the pen tip side casing 21E and the position of the through hole 22m of the rear end side casing 22E thereby coincides with the position of the protrusion 21q on the elastic piece 21p of the small-diameter structure 21Ej of the pen tip side casing 21E, the elastic piece 21p of the small-diameter structure 21Ej of the pen tip side casing 21E is elastically displaced in a direction intersecting the axial direction in such a manner as to insert the protrusion 21q into the through hole 22m of the rear end side casing 22E. The protrusion 21q on the elastic piece 21p of the small-diameter structure 21Ej of the pen tip side casing 21E is thereby fitted into the through hole 22m of the rear end side casing 22E, so that the rear end side casing 22D is locked and fixed to the pen tip side casing 21D.

When the rear end side casing 22E is rotated with the axial direction as a rotational center thereof with respect to the pen tip side casing 21E from this locked and fixed state, the fitting of the protrusion 21q on the elastic piece 21p of the small-diameter structure 21Ej of the pen tip side casing 21E to the through hole 22m of the rear end side casing 22E can be released, so that the pen tip side casing 21E and the rear end side casing 22E can be separated from each other easily.

Incidentally, while one U-shaped cut-out portion 21n and one elastic piece 21p may be provided to the small-diameter structure 21Ej, two or more U-shaped cut-out portions 21n and two or more elastic pieces 21p may be provided. However, these plurality of U-shaped cut-out portions 21n and elastic pieces 21p are provided at positions that are not at equal angular intervals.

It is to be noted that the example of FIGS. 14A and 14B is not limited to the case of the electronic pen 1 in which the electronic pen main body 3 is housed non-rotatably with respect to the pen tip side casing 21, but is also applicable to the case where the rear end side casing 22B non-rotatably housing the electronic pen main body 3B described with reference to FIGS. 9A to 9C is coupled to the pen tip side casing 21B. In this case, the formation position of the elastic piece 21p and the formation position of the through hole 22m are set not only in such a manner as to give consideration to alignment of the long hole direction of the elongated hole 22d on the rear end side of the rear end side casing 22D with respect to the position of the side switch operator 21SW of the pen tip side casing 21D but also in such a manner as to enable such alignment that the side switch operator 21SW of the pen tip side casing 21B is located directly above the switch driving operator 32 of the electronic pen main body 3B.

### Other Embodiments

In the electronic pen 1 described above, the rechargeable secondary battery 36 is provided in the electronic pen main body 3. However, the secondary battery may be provided on the additional unit side, for example, instead of in the electronic pen main body. In this case, the charging circuit for the secondary battery may be located in the electronic pen main body, or may be provided to the additional unit side.

In a case where the charging circuit is provided on the additional unit side, two contacts suffice as the contacts for connection between the electronic pen main body and the additional unit as in the foregoing example. In a case where the charging circuit is provided on the electronic pen main body side, however, a contact for charging is necessary, and therefore, three contacts are necessary.

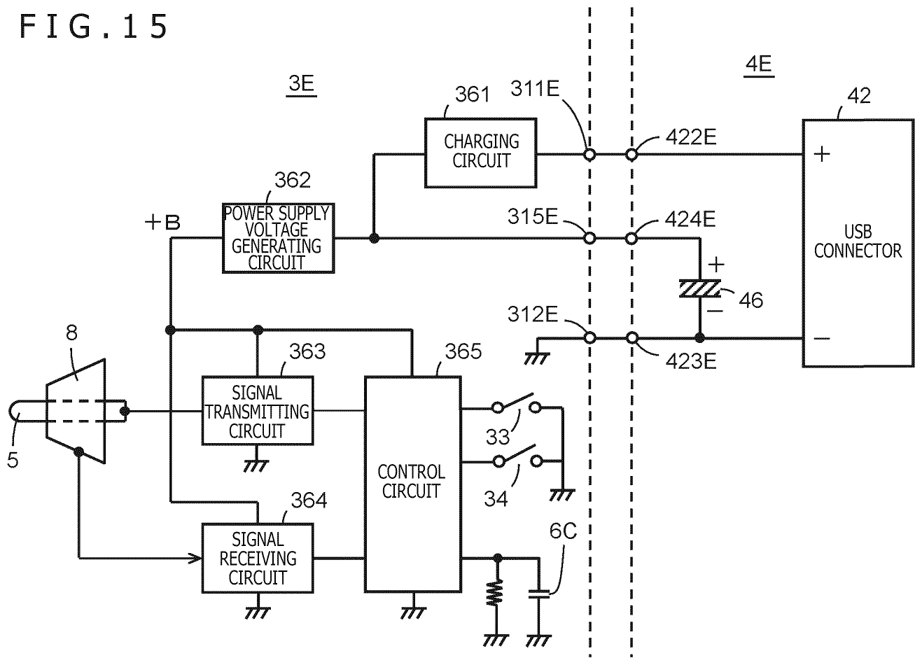

An electric configuration of an electronic pen main body 3E and an additional unit 4E in a case of such a configuration is one as illustrated in FIG. 15. This FIG. 15 is different from the electric configuration of the electronic pen main body 3 and the additional unit 4 illustrated in FIG. 7 in that a secondary battery 46 is provided in the additional unit 4E, three contacts 311E, 312E, and 315E are provided on the electronic pen main body 3E side, and three contacts 422E, 423E, and 424E are provided on the additional unit 4E side.

That is, in the example of FIG. 15, in the additional unit 4E, the contact 422E is connected to the power receiving terminal of the charging voltage of the USB connector 42, and the contact 423E is connected to the grounding terminal of the USB connector 42. In addition, the contact 424E is connected to the positive electrode terminal of the secondary battery 46 provided to the additional unit 4E. The negative electrode terminal of the secondary battery 46 is connected to the contact 423E.

Moreover, in the electronic pen main body 3E, the contact 311E connected to the contact 422E is connected to the input terminal of the charging circuit 361. The output terminal of the charging circuit 361 is connected to the input terminal of the power supply voltage generating circuit 362, and is connected to the positive electrode terminal of the secondary battery 46 provided to the additional unit 4E, via the contact 315E and the contact 424E.

The charging circuit 361 charges the secondary battery 46 by supplying a charging current based on the charging voltage input from the USB connector 42 through the contact 422E and the contact 311E to the secondary battery 46 via the contact 311E and the contact 424E.

The power supply voltage generating circuit 362 receives the voltage of the secondary battery 46 in the additional unit 4E through the contact 424E and the contact 315E, and generates the power supply voltage +B. The generated power supply voltage +B is supplied to the signal transmitting circuit 363, the signal receiving circuit 364, and the control circuit 365. The other configuration is similar to that of the circuit example of FIG. 7.

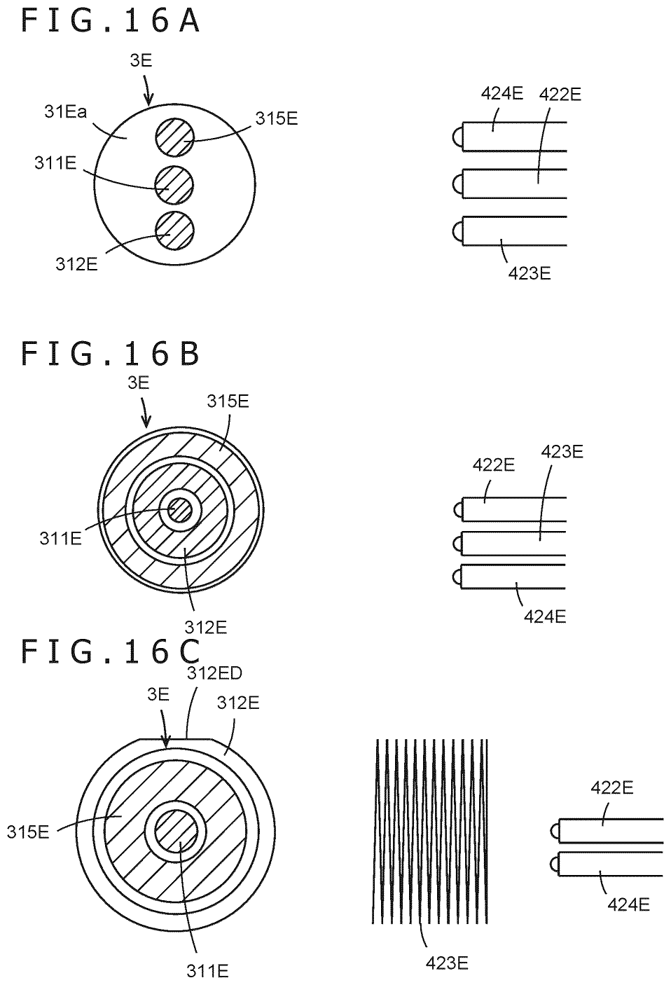

Examples of configurations of the three contacts 311E, 312E, and 315E on the electronic pen main body 3E side and examples of configurations of the three contacts 422E, 423E, and 424E on the additional unit 4E side in this case will be described with reference to FIGS. 16A to 16C. FIGS. 16A to 16C illustrate three configuration examples.

In the example of FIG. 16A, the three contacts 311E, 312E, and 315E are arranged side by side on a circular end surface 31Ea on the rear end side of the electronic pen main body 3E. In this case, the contact 311E is formed at a central position of the circular end surface 31Ea, and the contacts 312E and 315E are formed on both sides of the contact 311E. In the present example, the contact 312E corresponds to the second contact 312 of the terminal 31 in the foregoing embodiment, and has a D-cut shape portion 312ED.

Further, as illustrated on the right side of FIG. 16A, the three contacts 422E, 423E, and 424E on the additional unit 4E side are correspondingly provided side by side. In the present example, at a time of coupling between the electronic pen main body 3E and the additional unit 4E, alignment needs to be performed in such a manner as to connect the corresponding contacts to each other as in the foregoing example.

In the example of FIG. 16B, the three contacts 311E, 312E, and 315E are concentrically formed on the circular end surface 31Ea on the rear end side of the electronic pen main body 3E. In this case, the contact 311E is formed at the central position of the circular end surface 31Ea, the contact 312E in a ring shape is formed on the outside of the contact 311E, and further, the contact 315E is formed on the outside of the contact 312E.

Moreover, as illustrated on the right side of FIG. 16B, the three contacts 422E, 423E, and 424E on the additional unit 4E side are provided in such positions as to be connectable to the central electrode 311E and the ring-shaped contacts 312E and 315E, respectively. In the present example, alignment for connecting the corresponding contacts to each other is unnecessary at a time of coupling between the electronic pen main body 3E and the additional unit 4E.

In the example of FIG. 16C, the contact 311E and the contact 315E are concentrically formed on the circular end surface 31Ea on the rear end side of the electronic pen main body 3E. Moreover, as with the second contact 312 of the terminal 31 of the electronic pen main body 3, the contact 312E has a configuration of a ring contact in a flange shape protruding from the periphery of the electronic pen main body 3E.

Further, as illustrated on the right side of FIG. 16C, of the three contacts 422E, 423E, and 424E on the additional unit 4E side, the contact 422E and the contact 424E are provided in such positions as to be connectable to the central electrode 311E and the ring-shaped contact 315E, respectively. Moreover, the contact 423E is configured, as a configuration of a conductive coil, to be connected to the contact 312E, which is a ring contact in a flange shape. The contact 422E and the contact 424E is configured to be arranged in the conductive coil of the contact 423E. In the present example, alignment for connecting the corresponding contacts to each other is unnecessary at a time of coupling between the electronic pen main body 3E and the additional unit 4E.

It is to be noted that the configuration of an electric connection part between the electronic pen main body and the additional unit is not limited to the configuration in which an electric connection is established by pressing a plurality of contact pins (pogo pins) as in the foregoing example against a terminal surface, and various other configurations are possible.

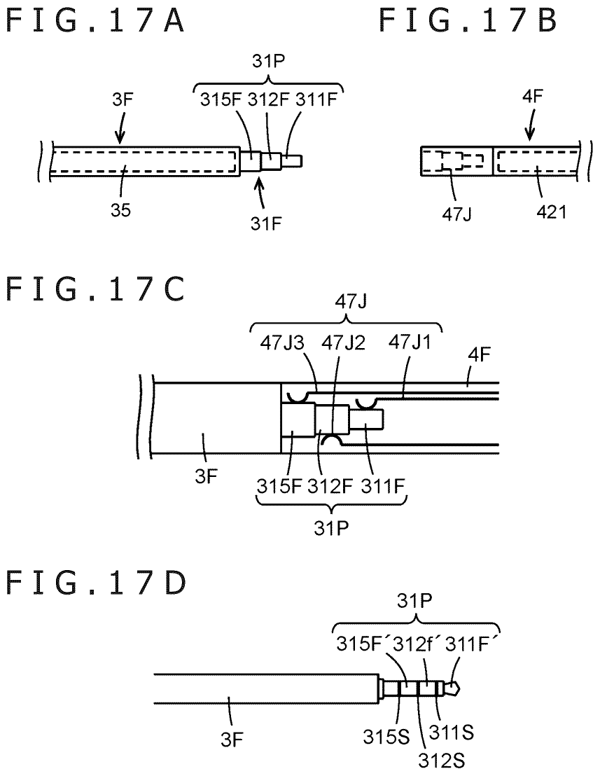

FIGS. 17A to 17D are diagrams illustrating other examples of the configuration of the electric connection part between the electronic pen main body and the additional unit. A connector plug 31P is provided on the rear end side of an electronic pen main body 3F in the present example. Moreover, an additional unit 4F in the present example is provided with a connector jack 47J into which the connector plug 31P is fitted.

FIGS. 17A to 17C are diagrams explaining a first configuration example of the connector plug 31P of the electronic pen main body 3F and the connector jack 47J of the additional unit 4F. In addition, FIG. 17D is a diagram explaining a second configuration example. Each of the examples of FIGS. 17A to 17D is an example in a case where the number of contacts is three.

As illustrated in FIG. 17A, the connector plug 31P in the first configuration example is provided as a terminal 31F of the electronic pen main body 3F. In addition, as illustrated in FIG. 17B, the connector jack 47J in the first configuration example is provided in a fitting of the additional unit 4F which is fitted with the terminal 31F of the electronic pen main body 3F. FIG. 17C is a diagram explaining an electric connection relation between the connector plug 31P and the connector jack 47J in the first configuration example.

The connector plug 31P of the electronic pen main body 3F is electrically coupled to an electronic circuit formed on the circuit board 35 of the electronic pen main body 3F, and has a plurality of terminals, or three contacts 311F, 312F, and 315F in the present example, which are insulated from each other. The three contacts 311F, 312F, and 315F respectively correspond to the three contacts 311E, 312E, and 315E of the electronic pen main body 3E described above.

The three contacts 311F, 312F, and 315F of the connector plug 31P in the first configuration example provided to the electronic pen main body 3F are configured as follows. That is, in the present example, the contact 311F is formed of a conductor metal constituting a central core rod. Further, the connector plug 31P in the present example is formed by concentrically combining cylindrical contacts 312F and 315F having an insulating layer formed on respective inner wall surfaces thereof with the rod-shaped conductor metal of the contact 311F.

In this case, as illustrated in FIG. 17A, the contact 311F of the conductor metal constituting the central core rod is formed as a distal end in the axial direction, an annular circumferential surface and a distal end of the contact 311F are exposed by a predetermined length in the axial direction, and the cylindrical contacts 312F and 315F each have an annular circumferential surface thereof exposed by a predetermined length in the axial direction. That is, annular conductor contacts of the three contacts 311F, 312F, and 315F of the connector plug 31P are exposed at different positions in the axial direction. Incidentally, the contact 311F has a cylindrical shape, and an annular peripheral side surface and the distal end thereof constitute the conductor contact.

Moreover, the connector jack 47J of the additional unit 4F has a recess into which the connector plug 31P is inserted, as illustrated in FIG. 17B, and the recess is provided with three contacts 47J1, 47J2, and 47J3 that come into elastic contact with the three contacts 311F, 312F, and 315F of the connector plug 31P, as illustrated in FIG. 17C. The three contacts 47J1, 47J2, and 47J3 are formed of a conductive elastic metal. The three contacts 47J1, 47J2, and 47J3 of the additional unit 4F described above respectively correspond to the three contacts 422E, 423E, and 424E of the additional unit 4E described above, and are connected to an electronic circuit disposed on the circuit board 421 of the additional unit 4F.

When the connector plug 31P of the electronic pen main body 3F is inserted into the connector jack 47J of the additional unit 4F, as illustrated in FIG. 17C, the three contacts 311F, 312F, and 315F of the connector plug 31P are elastically connected to the three contacts 47J1, 47J2, and 47J3, respectively, which are provided to the connector jack 47J. An electronic circuit similar to the electronic circuit illustrated in FIG. 15 is thereby formed. Thus, a power supply voltage is supplied from the secondary battery 46 of the additional unit 4F to the electronic pen main body 3F, and the secondary battery 46 is configured to be chargeable.

Next, in the electronic pen main body 3F in the second configuration example of FIG. 17D, three contacts 311F′, 312F′, and 315F′ of the connector plug 31P are configured as follows. The connector plug 31P in the present example has a configuration similar to that of a pin plug for audio, for example. In the present example, the three contacts 311F′, 312F′, and 315F′ have annular conductor contacts of the same diameter exposed at different positions in the axial direction.

Specifically, the contact 311F′ at a distal end among the three contacts 311F′, 312F′, and 315F′ is a tip contact, and the two intermediate contacts 312F′ and 315F′ are annular terminals insulated from the other contacts by respective insulating rings 311S, 312S, and 315S.

A configuration of a connector jack of the additional unit 4F to be coupled to the connector plug 31P of the electronic pen main body 3F in the second configuration example is well known, and is therefore not illustrated in the figure. As in the foregoing first configuration example, the connector jack of the additional unit 4F includes three contacts that come into contact with the respective annular conductor contacts of the three contacts 311F′, 312F′, and 315F′ to form an electric connection.

As described above, in the examples illustrated in FIGS. 17A to 17D, an electric connection between the electronic pen main body 3F and the additional unit 4F is made as in the foregoing embodiment by inserting and fitting the connector plug 31P provided to the electronic pen main body 3F into the connector jack 47J provided to the additional unit 4F.

In this case, in the examples of FIGS. 17A to 17D, the conductor contacts of the annular contacts of the connector plug 31P are connected to the respective conductor contacts of the contacts of the connector jack 47J. Thus, even when the electronic pen main body 3F rotates about a center line in the axial direction, the electric connection is maintained at all times, and an electric noncontact state can be avoided. That is, a positioning member for alignment for connection between a plurality of contacts is unnecessary at a time of coupling between the electronic pen main body 3F and the additional unit 4F.

Incidentally, in the examples of FIGS. 17A to 17D, there is adopted a configuration in which the connector plug is provided to the electronic pen main body 3F and the connector jack is provided to the additional unit 4F side. However, conversely, a configuration in which the connector jack is provided to the electronic pen main body 3F, and the connector plug is provided to the additional unit 4F side may be adopted.

### Other Embodiments or Modifications

Incidentally, in the case of an embodiment in which a battery is provided to the additional unit side, a primary battery may be used as a power supply in place of the secondary battery.

In the foregoing embodiments, the electronic pen main body of the electronic pen is of a configuration in the case of an active capacitive electronic pen. However, it is needless to say that the electronic pen main body can be of a configuration in a case of an electromagnetic induction type electronic pen.

It is to be noted that the embodiment of the present disclosure is not limited to the foregoing embodiments, and that various changes can be made without departing from the spirit of the present disclosure.

1. An electronic pen comprising:
a first casing and a second casing configured to couple to each other in an axial direction and form an outer casing;
an electronic pen main body configured to perform signal interaction with a position detecting sensor, that has a columnar shape capable of being housed in the outer casing, and that is capable of being fitted with a core body on one end side in the axial direction; and
an additional unit disposed on a side of the electronic pen main body opposite to the side fitted with core body in the axial direction and electrically coupled to the electronic pen main body, wherein
the electronic pen main body has an electric first terminal on a side opposite to the side fitted with the core body,
the additional unit has a columnar shape capable of being housed in the outer casing and has a second terminal on one end side in the axial direction, the second terminal being configured to be electrically coupled to the first terminal of the electronic pen main body, and,
in the outer casing, the electronic pen main body and the additional unit, arranged in such a manner as to be aligned with each other in the axial direction when the additional unit is on a rear end side, are set in a state of being incapable of movement in the axial direction, the first terminal and the second terminal are set in a state of being electrically coupled to each other, and at least the electronic pen main body is set in a state of being incapable of rotation about the axial direction with respect to the outer casing.

2. The electronic pen according to claim 1, wherein
the electronic pen main body and the additional unit in the outer casing are set in a state of being incapable of rotation about the axial direction with respect to the outer casing.

3. The electronic pen according to claim 1, wherein
the electronic pen main body has a rotation suppressing structure for suppressing the rotation about the axial direction, and the first casing has an engaging structure configured to engage with the rotation suppressing structure of the electronic pen main body.

4. The electronic pen according to claim 1, wherein
the first casing and the second casing are incapable of rotation relative to each other in a coupled state, and
the electronic pen main body has a rotation suppressing structure for suppressing the rotation about the axial direction, and the first casing or the second casing has an engaging structure configured to engage with the rotation suppressing structure of the electronic pen main body.

5. The electronic pen according to claim 2, wherein
the electronic pen main body has a rotation suppressing structure for suppressing the rotation about the axial direction, and
the additional unit has an engaging structure configured to engage with the rotation suppressing structure and is coupled to the electronic pen main body in the axial direction.

6. The electronic pen according to claim 3, wherein
the rotation suppressing structure has a D-cut shape.

7. The electronic pen according to claim 3, wherein
the rotation suppressing structure is a protrusion or a recess, and the engaging structure is a recess or a protrusion that is configured to engage with the rotation suppressing structure.

8. The electronic pen according to claim 1, wherein
the electronic pen main body has a switch in an intermediate portion of the electronic pen main body unit in the axial direction, the switch being configured to be subjected to on and off control by a depression force in a direction orthogonal to the axial direction, and
the first casing has a pen tip side opening configured to protrude a distal end of the core body outward and has a switch operator for a depressing operation of the switch in an intermediate portion of the first casing in the axial direction, the intermediate portion corresponding to the switch of the electronic pen main body set in the state of being incapable of the rotation about the axial direction.

9. The electronic pen according to claim 8, wherein
the electronic pen main body has a rotation suppressing structure for suppressing the rotation about the axial direction, and the first casing has an engaging structure configured to engage with the rotation suppressing structure of the electronic pen main body, and
alignment between the switch of the electronic pen main body and the switch operator of the first casing is performed by engagement of the rotation suppressing structure and the engaging structure with each other.

10. The electronic pen according to claim 8, wherein
the electronic pen main body has a rotation suppressing structure for suppressing the rotation about the axial direction, and the second casing has an engaging structure configured to engage with the rotation suppressing structure of the electronic pen main body, and
the first casing and the second casing are coupled to each other in a state of being incapable of rotation relative to each other, one having a protrusion and the other having a recess, and, in the coupled state, alignment between the switch of the electronic pen main body and the switch operator of the first casing is performed by fitting the recess to the protrusion.

11. The electronic pen according to claim 8, wherein
the electronic pen main body has a rotation suppressing structure for suppressing the rotation about the axial direction, and the additional unit is configured to be coupled to the electronic pen main body in the axial direction, has an engaging structure configured to engage with the rotation suppressing structure, and is disposed in a state of being incapable of rotation about the axial direction in the second casing, and
the first casing and the second casing are coupled to each other in a state of being incapable of rotation relative to each other, one having a protrusion and the other having a recess, and, in the coupled state, alignment between the switch of the electronic pen main body and the switch operator of the first casing is performed by fitting the recess to the protrusion.

12. The electronic pen according to claim 1, wherein
the first casing and the second casing are coupled to each other by being screwed.

13. The electronic pen according to claim 1, wherein
the electronic pen main body has the first terminal on a first end surface on a side in the axial direction opposite to the side fitted with the core body,
the additional unit has the second terminal on a second end surface on one end side in the axial direction, and,
in the outer casing, when the first end surface on which the first terminal is disposed and the second end surface on which the second terminal is disposed face each other, the electronic pen main body and the additional unit are arranged in such a manner as to be aligned with each other in the axial direction, and at least one of the first terminal on the first end surface and the second terminal on the second end surface is configured to be elastically displaceable in the axial direction.

14. The electronic pen according to claim 13, wherein
at least one of the first terminal on the first end surface and the second terminal on the second end surface includes a contact probe configured to be elastically displaceable in the axial direction.

15. The electronic pen according to claim 1, wherein
the electronic pen main body includes a rechargeable secondary battery as a power supply, and
the additional unit includes a charging terminal for the secondary battery, the charging terminal being capable of being exposed outward through the second casing.

16. The electronic pen according to claim 1, wherein
the additional unit includes a rechargeable secondary battery as a power supply and includes a charging terminal capable of being exposed outward through the second casing.

17. The electronic pen according to claim 1, wherein
the electronic pen main body and the additional unit are configured such that, in the axial direction, either the electronic pen main body or the additional unit is inserted in a recess provided in the other that is not being inserted and are configured to be locked to each other when the first terminal and the second terminal are electrically coupled to each other.

18. The electronic pen according to claim 6, wherein
the D-cut portion of the rotation suppressing structure has a shape protruding in a ring shape from a side circumferential surface of a columnar-shaped casing of the electronic pen main body.

19. The electronic pen according to claim 18, wherein
the D-cut portion constitutes one of contacts of the first terminal.

20. The electronic pen according to claim 1, wherein
the electronic pen main body has an electromagnetic induction system.

21. The electronic pen according to claim 1, wherein
the electronic pen main body has an active capacitive system.

22. The electronic pen according to claim 1, wherein
the first terminal of the electronic pen main body has a first connector plug or a first connector jack, and the second terminal of the additional unit has a second connector jack or a second connector plug configured to be fitted to the first connector plug or the first connector jack of the first terminal of the electronic pen main body.
